(19) United States
(12) Patent Application Publication
(10) Pub. No.: US 2025/0379914 A1
(43) Pub. Date: Dec. 11, 2025

(54) TECHNIQUES FOR SYNCHRONIZING DATA

(71) Applicant: Apple Inc., Cupertino, CA (US)

(72) Inventors: Dale A. TAYLOR, Menlo Park, CA (US); Felipe Marin CYPRIANO, San Francisco, CA (US); David A. MOORE, Santa Clara, CA (US); Steven A. MYERS, San Jose, CA (US)

(21) Appl. No.: 19/039,269

(22) Filed: Jan. 28, 2025

Related U.S. Application Data
(60) Provisional application No. 63/657,385, filed on Jun. 7, 2024.

(51) Int. Cl. H04L 67/306; H04L 9/08

(52) U.S. Cl. CPC H04L 67/306; H04L 9/0825

(57) ABSTRACT

The present disclosure generally relates to synchronizing data. Some techniques are for automatically synchronizing data in accordance with some embodiments. Other techniques are for causing data to be available based on presence in accordance with some embodiments.

### CROSS-REFERENCE TO RELATED APPLICATIONS

The present application claims priority to U.S. Provisional Patent Application Ser. No. 63/657,385, entitled “TECHNIQUES FOR SYNCHRONIZING DATA” filed Jun. 7, 2024, which is hereby incorporated by reference in its entirety for all purposes.

### BACKGROUND

Synchronizing account settings across multiple devices has become increasingly challenging. For instance, user accounts (e.g., email, social media, and cloud storage) are frequently accessed from various devices (e.g., smartphones, tablets, and laptops). Logging into each device individually to synchronize settings can be cumbersome and time-consuming. Consequently, there is a need to enhance methods for synchronizing account settings seamlessly across different devices.

### SUMMARY

Current techniques for synchronizing data are generally ineffective and/or inefficient. For example, some techniques require users to login to devices individually with login credentials. This disclosure provides more effective and/or efficient techniques for synchronizing data using examples of logging into different accessory devices. It should be recognized that other types of electronic devices can be used with techniques described herein. For example, a smartphone can connect with a laptop to synchronize settings using the techniques described within. In addition, techniques optionally complement or replace other techniques for synchronizing data.

Some techniques are described herein for an accessory device to cause a personal device to log into the accessory device. Other techniques are described herein for providing access to restricted data based on proximity of a user.

In some embodiments, a method that is performed by a first device is described. In some embodiments, the method comprises: sending, to a second device, a request to sign a first user account into the first device different from the second device; after the request to sign the first user account into the first device is sent, receiving, from the second device, a response to the request to sign the first user account into the first device, wherein the response includes a request for data corresponding to the first device; in response to receiving the response, sending, to the second device, data indicative of a group; after sending the data indicative of the group, receiving, from the second device, data corresponding to the first user account; and in response to receiving the data corresponding to the first user account, signing the first user account into the first device.

In some embodiments, a non-transitory computer-readable storage medium storing one or more programs configured to be executed by one or more processors of a first device is described. In some embodiments, the one or more programs includes instructions for: sending, to a second device, a request to sign a first user account into the first device different from the second device; after the request to sign the first user account into the first device is sent, receiving, from the second device, a response to the request to sign the first user account into the first device, wherein the response includes a request for data corresponding to the first device; in response to receiving the response, sending, to the second device, data indicative of a group; after sending the data indicative of the group, receiving, from the second device, data corresponding to the first user account; and in response to receiving the data corresponding to the first user account, signing the first user account into the first device.

In some embodiments, a transitory computer-readable storage medium storing one or more programs configured to be executed by one or more processors of a first device is described. In some embodiments, the one or more programs includes instructions for: sending, to a second device, a request to sign a first user account into the first device different from the second device; after the request to sign the first user account into the first device is sent, receiving, from the second device, a response to the request to sign the first user account into the first device, wherein the response includes a request for data corresponding to the first device; in response to receiving the response, sending, to the second device, data indicative of a group; after sending the data indicative of the group, receiving, from the second device, data corresponding to the first user account; and in response to receiving the data corresponding to the first user account, signing the first user account into the first device.

In some embodiments, a first device comprising one or more processors and memory storing one or more programs configured to be executed by the one or more processors is described. In some embodiments, the one or more programs includes instructions for: sending, to a second device, a request to sign a first user account into the first device different from the second device; after the request to sign the first user account into the first device is sent, receiving, from the second device, a response to the request to sign the first user account into the first device, wherein the response includes a request for data corresponding to the first device; in response to receiving the response, sending, to the second device, data indicative of a group; after sending the data indicative of the group, receiving, from the second device, data corresponding to the first user account; and in response to receiving the data corresponding to the first user account, signing the first user account into the first device.

In some embodiments, a first device is described. In some embodiments, the first device comprises means for performing each of the following steps: sending, to a second device, a request to sign a first user account into the first device different from the second device; after the request to sign the first user account into the first device is sent, receiving, from the second device, a response to the request to sign the first user account into the first device, wherein the response includes a request for data corresponding to the first device; in response to receiving the response, sending, to the second device, data indicative of a group; after sending the data indicative of the group, receiving, from the second device, data corresponding to the first user account; and in response to receiving the data corresponding to the first user account, signing the first user account into the first device.

In some embodiments, a computer program product is described. In some embodiments, the computer program product comprises one or more programs configured to be executed by one or more processors of a first device. In some embodiments, the one or more programs include instructions for: sending, to a second device, a request to sign a first user account into the first device different from the second device; after the request to sign the first user account into the first device is sent, receiving, from the second device, a response to the request to sign the first user account into the first device, wherein the response includes a request for data corresponding to the first device; in response to receiving the response, sending, to the second device, data indicative of a group; after sending the data indicative of the group, receiving, from the second device, data corresponding to the first user account; and in response to receiving the data corresponding to the first user account, signing the first user account into the first device.

In some embodiments, a method that is performed at a device is described. In some embodiments, the method comprises: while a first set of data corresponding to a user is unavailable to the device, detecting a presence of the user; in response to detecting the presence of the user, accessing the first set of data corresponding to the user; after accessing the first set of data corresponding to the user, detecting that the user is no longer present; and in response to detecting that the user is no longer present, ceasing access of the first set of data.

In some embodiments, a non-transitory computer-readable storage medium storing one or more programs configured to be executed by one or more processors of a device is described. In some embodiments, the one or more programs includes instructions for: while a first set of data corresponding to a user is unavailable to the device, detecting a presence of the user; in response to detecting the presence of the user, accessing the first set of data corresponding to the user; after accessing the first set of data corresponding to the user, detecting that the user is no longer present; and in response to detecting that the user is no longer present, ceasing access of the first set of data.

In some embodiments, a transitory computer-readable storage medium storing one or more programs configured to be executed by one or more processors of a device is described. In some embodiments, the one or more programs includes instructions for: while a first set of data corresponding to a user is unavailable to the device, detecting a presence of the user; in response to detecting the presence of the user, accessing the first set of data corresponding to the user; after accessing the first set of data corresponding to the user, detecting that the user is no longer present; and in response to detecting that the user is no longer present, ceasing access of the first set of data.

In some embodiments, a device is described. In some embodiments, the device comprises one or more processors and memory storing one or more programs configured to be executed by the one or more processors. In some embodiments, the one or more programs includes instructions for: while a first set of data corresponding to a user is unavailable to the device, detecting a presence of the user; in response to detecting the presence of the user, accessing the first set of data corresponding to the user; after accessing the first set of data corresponding to the user, detecting that the user is no longer present; and in response to detecting that the user is no longer present, ceasing access of the first set of data.

In some embodiments, a device is described. In some embodiments, the device comprises means for performing each of the following steps: while a first set of data corresponding to a user is unavailable to the device, detecting a presence of the user; in response to detecting the presence of the user, accessing the first set of data corresponding to the user; after accessing the first set of data corresponding to the user, detecting that the user is no longer present; and in response to detecting that the user is no longer present, ceasing access of the first set of data.

In some embodiments, a computer program product is described. In some embodiments, the computer program product comprises one or more programs configured to be executed by one or more processors of a device. In some embodiments, the one or more programs include instructions for: while a first set of data corresponding to a user is unavailable to the device, detecting a presence of the user; in response to detecting the presence of the user, accessing the first set of data corresponding to the user; after accessing the first set of data corresponding to the user, detecting that the user is no longer present; and in response to detecting that the user is no longer present, ceasing access of the first set of data.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIG. 1B is a flow diagram illustrating a process for an application in accordance with some embodiments.

FIG. 1C is a flow diagram illustrating another process for an application in accordance with some embodiments.

FIG. 1D is a block diagram illustrating a device in accordance with some embodiments.

FIG. 2 is a block diagram illustrating a device with interconnected subsystems in accordance with some embodiments.

FIGS. 3A-3F illustrate exemplary user interfaces for synchronizing data in accordance with some embodiments.

FIG. 4 is a flow diagram illustrating a process for automatically synchronizing data in accordance with some embodiments.

FIG. 5 is a flow diagram illustrating a process for causing data to be available based on presence in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

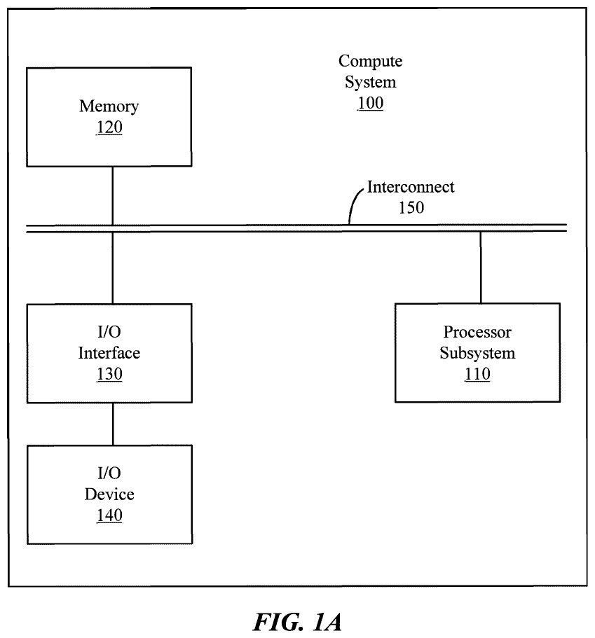

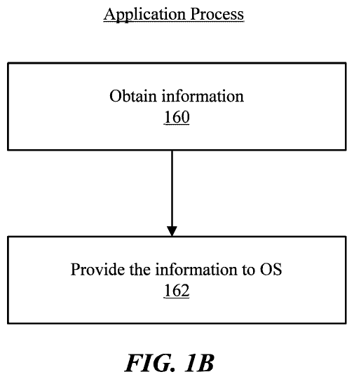

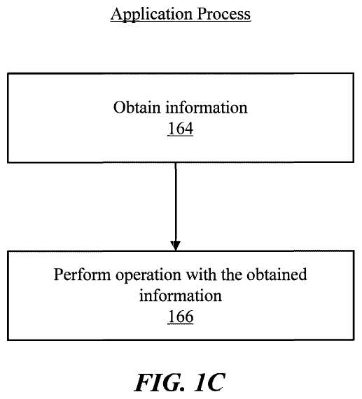

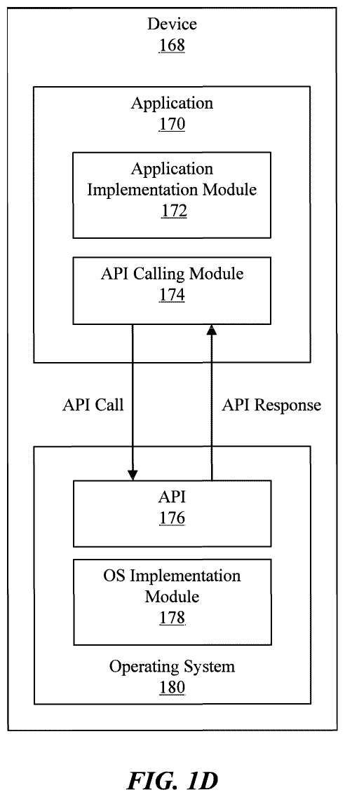

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LIDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

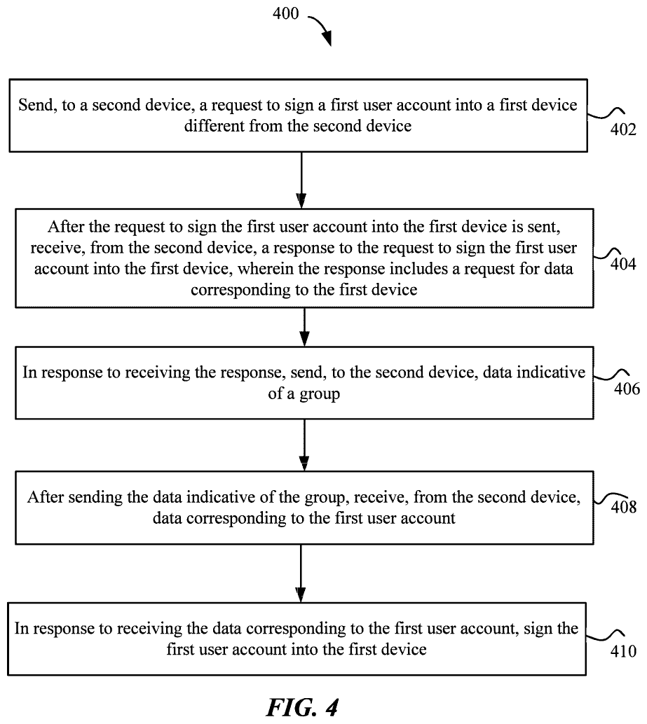

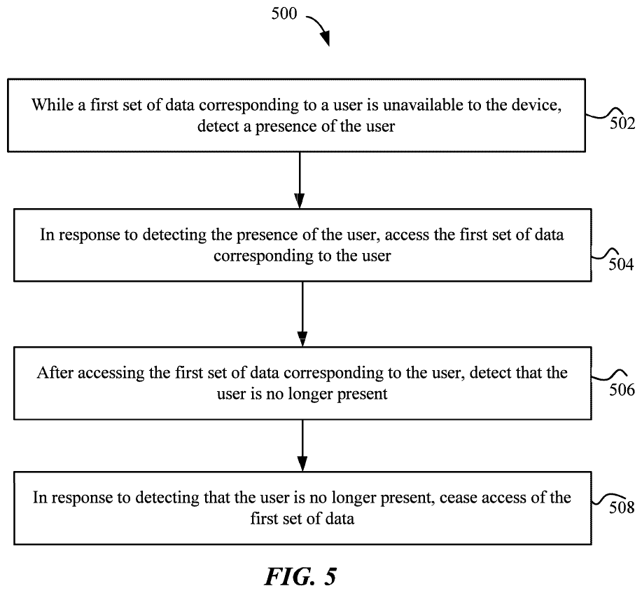

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 400 and 500 (FIGS. 4 and 5) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 can be any suitable type of application, including, for example, one or more of: a messaging application, a maps application, a fitness application, a health application, a digital payments application, a media application, and/or a social network application. In some embodiments, application 170 is an application that is pre-installed on device 168 at purchase (e.g., a first party application). In other embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In other embodiments, the application store is a third-party application store (e.g., an application store that is provided by another application store, downloaded via a network, and/or read from a storage device).

Referring to FIG. 1B, application 170 obtains information (e.g., 160). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to operating system (e.g., 162).

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. in response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of operating system 180 based on the information.

In some embodiments, one or more steps of the process of FIG. 1B and/or the process of FIG. 1C is performed in response to a trigger. In some embodiments, the trigger includes detection of an event, a notification received from operating system 180, a user input, and/or a response to a call to an API provided by operating system 180.

In some embodiments, the instructions of application 170, when executed, control device 168 to perform the process of FIG. 1B and/or the process of FIG. 1C by calling an application programming interface (API) (e.g., API 176) provided by operating system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. As illustrated in FIG. 1D, device 168 includes application 170 and operating system 180. Application 170 includes application implementation module 172 and API calling module 174. Operating system 180 includes API 176 and OS implementation module 178. It should be recognized that device 168, application 170, and/or operating system 180 can include more, fewer, and/or different components than illustrated in FIG. 1D.

In some embodiments, application implementation module 172 includes a set of one or more instructions corresponding to one or more operations performed by application 170. For example, when application 170 is a messaging application, application implementation module 172 can include operations to receive and send messages. In some embodiments, application implementation module 172 communicates with API calling module to communicate with operating system 180 via API 176.

In some embodiments, API 176 is a software module (e.g., a collection of computer-readable instructions) that provides an interface that allows a different module (e.g., API calling module 174) to access and/or use one or more functions, processes, procedures, data structures, classes, and/or other services provided by OS implementation module 178 of operating system 180. For example, API-calling module 174 can access a feature of OS implementation module 178 through one or more API calls or invocations (e.g., embodied by a function or a process call) exposed by API 176 and can pass data and/or control information using one or more parameters via the API calls or invocations. In some embodiments, API 176 allows application 170 to use a service provided by a Software Development Kit (SDK) library. In other embodiments, application 170 incorporates a call to a function or process provided by the SDK library and provided by API 176 or uses data types or objects defined in the SDK library and provided by API 176. In some embodiments, API-calling module 174 makes an API call via API 176 to access and use a feature of OS implementation module 178 that is specified by API 176. In such embodiments, OS implementation module 178 can return a value via API 176 to API-calling module 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API-calling module 174 (which can be a third-party developer) to leverage a feature provided by OS implementation module 178. In such embodiments, there can be one or more API-calling modules (e.g., including API-calling module 174) that communicate with OS implementation module 178. In some embodiments, API 176 allows multiple API-calling modules written in different programming languages to communicate with OS implementation module 178 (e.g., API 176 can include features for translating calls and returns between OS implementation module 178 and API-calling module 174) while API 176 is implemented in terms of a specific programming language. In some embodiments, API-calling module 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, OS implementation module 178 is an operating system software module (e.g., a collection of computer-readable instructions) that is constructed to perform an operation in response to receiving an API call via API 176. In some embodiments, OS implementation module 178 is constructed to provide an API response (via API 176) as a result of processing an API call. By way of example, OS implementation module 178 and API-calling module 174 can each be any one of an operating system, a library, a device driver, an API, an application program, or other module. It should be understood that OS implementation module 178 and API-calling module 174 can be the same or different type of module from each other. In some embodiments, OS implementation module 178 is embodied at least in part in firmware, microcode, or other hardware logic.

In some embodiments, OS implementation module 178 returns a value through API 176 in response to an API call from API-calling module 174. While API 176 defines the syntax and result of an API call (e.g., how to invoke the API call and what the API call docs), API 176 might not reveal how OS implementation module 178 accomplishes the function specified by the API call. Various API calls are transferred via the one or more application programming interfaces between API-calling module 174 and OS implementation module 178. Transferring the API calls can include issuing, initiating, invoking, calling, receiving, returning, and/or responding to the function calls or messages. In other words, transferring can describe actions by either of API-calling module 174 or OS implementation module 178. In some embodiments, a function call or other invocation of API 176 sends and/or receives one or more parameters through a parameter list or other structure.

In some embodiments, OS implementation module 178 provides more than one API, each providing a different view of or with different aspects of functionality implemented by OS implementation module 178. For example, one API of OS implementation module 178 can provide a first set of functions and can be exposed to third party developers, and another API of OS implementation module 178 can be hidden (e.g., not exposed) and provide a subset of the first set of functions and also provide another set of functions, such as testing or debugging functions which are not in the first set of functions. In some embodiments, OS implementation module 178 calls one or more other components via an underlying API and thus be both an API calling module and an OS implementation module. It should be recognized that OS implementation module 178 can include additional functions, processes, classes, data structures, and/or other features that are not specified through API 176 and are not available to API calling module 174. It should also be recognized that API calling module 174 can be on the same system as OS implementation module 178 or can be located remotely and access OS implementation module 178 using API 176 over a network. In some embodiments, OS implementation module 178, API 176, and/or API-calling module 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

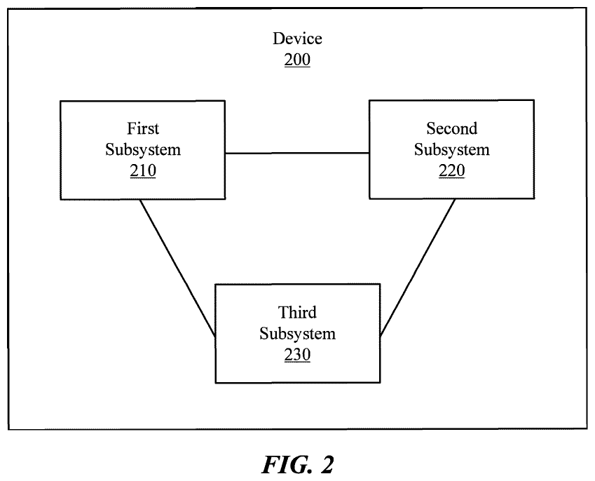

FIG. 2 illustrates a block diagram of device 200 with interconnected subsystems. In the illustrated example, device 200 includes three different subsystems (i.e., first subsystem 180, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 180 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 180, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 180 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 180 and a second portion is executed by second subsystem 220.

Attention is now directed towards techniques for synchronizing data. Such techniques are described in the context of synchronizing accessory devices. It should be recognized that other types of electronic devices can be used with techniques described herein. For example, a phone can synchronize with another phone using techniques described herein. In addition, techniques optionally complement or replace other techniques for synchronizing data.

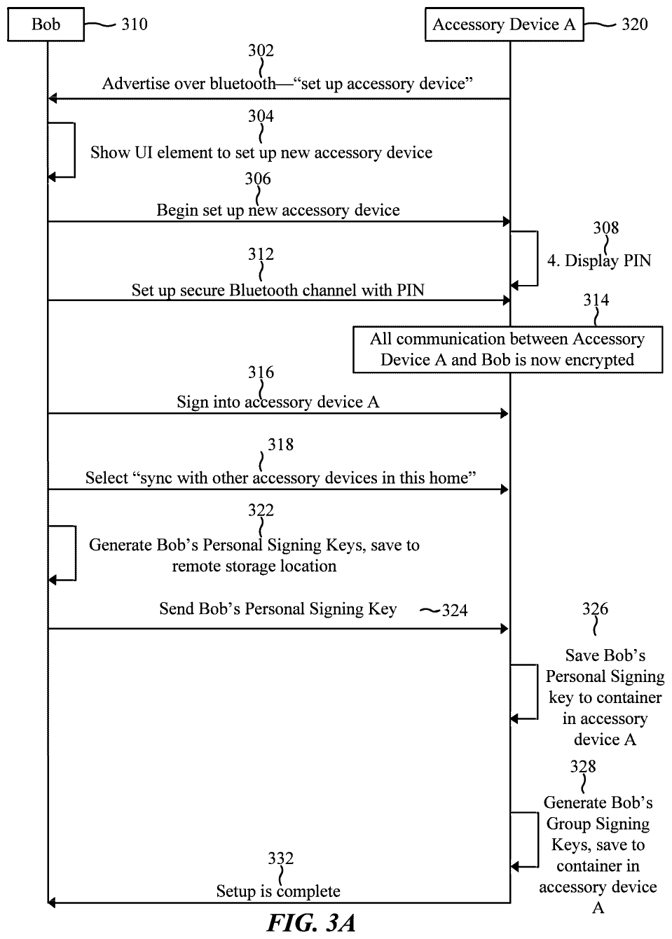

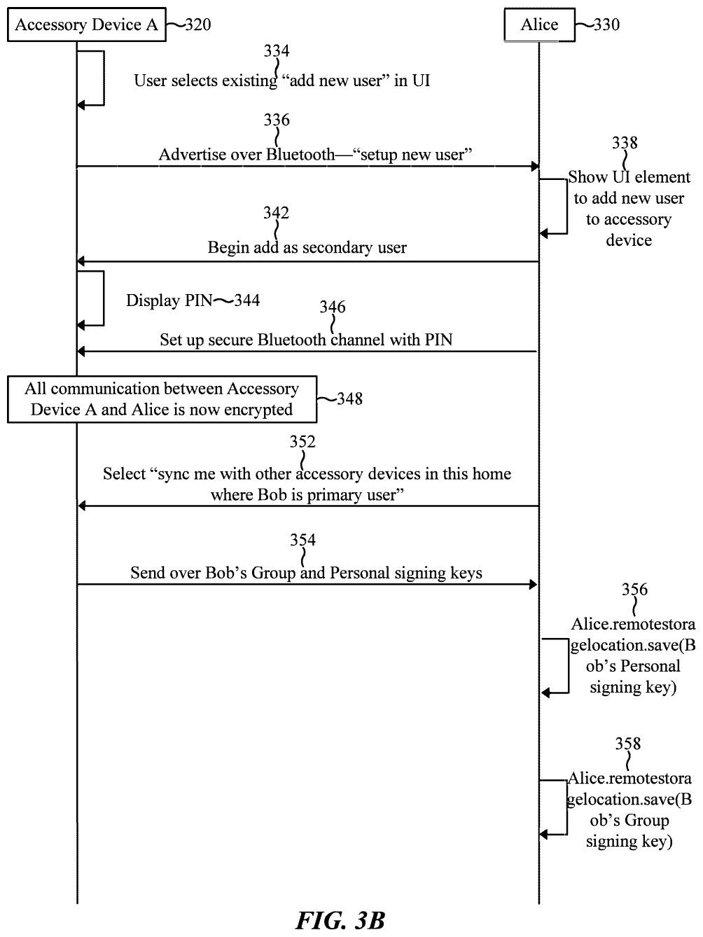

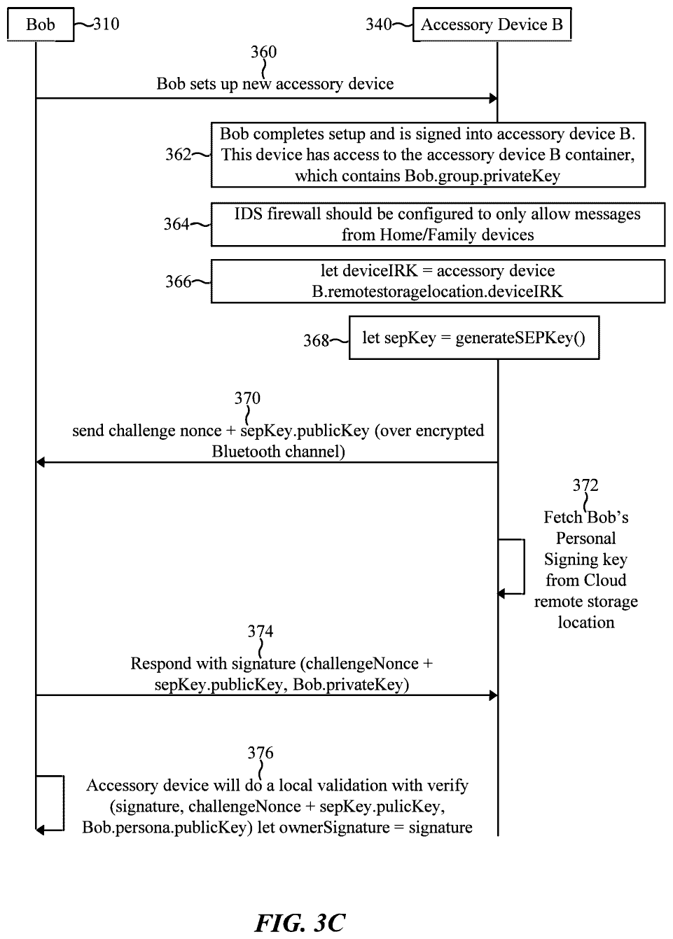

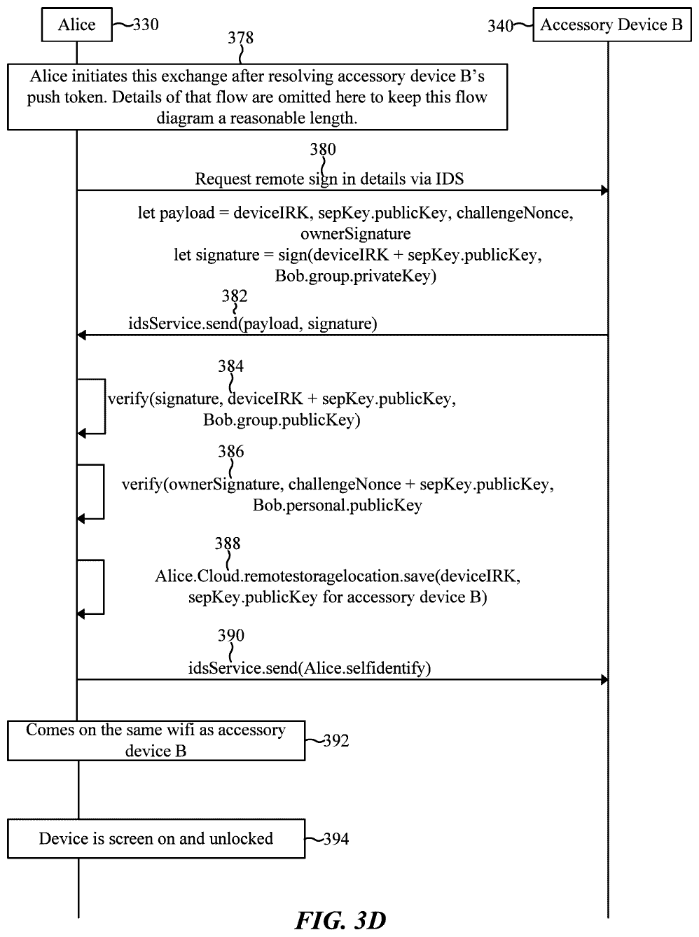

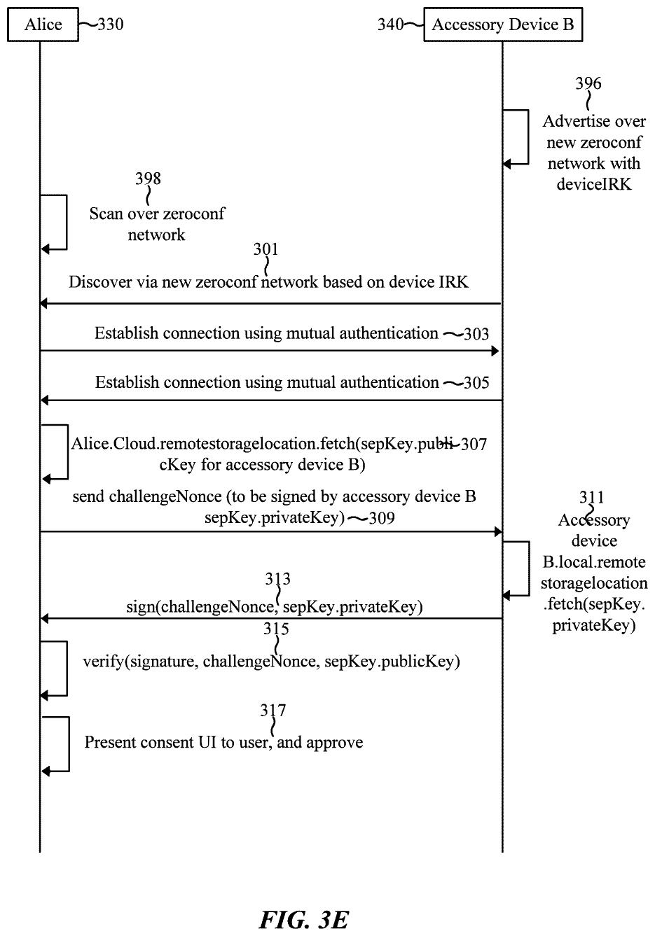

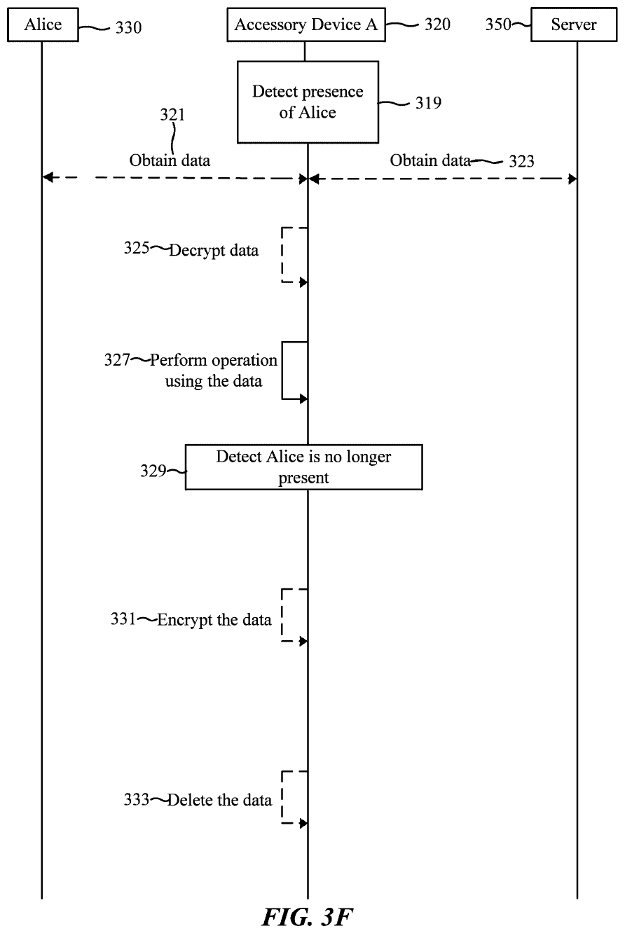

FIGS. 3A-3F are swim-lane diagrams illustrating a process for synchronizing settings in accordance with some embodiments. Synchronizing settings can include sending and/or receiving data corresponding to a user's account between devices to setup and/or maintain the data on each device. Examples of such data include a list of paired devices, biometric data, media (e.g., songs, images, videos, and/or audio recordings), documents, contacts, messages, a list of calls (e.g., missed calls and/or previous calls), a list of applications installed on one or more of the devices, language preference, voice recognition data, font size, color preferences for user interfaces, a list of networks, usernames and/or passwords, notification preference, sound preference, haptic preference, content watch history, controls for accessories, and media playback preference. In some embodiments, certain data like playlist history for music is stored and/or sent as unencrypted data. This unencrypted data can be readily accessed and transferred between devices without additional security measures. For example, a user's music playlist history might be sent directly to another device, once signed in to a user account, to ensure seamless music playback continuity. In some embodiments, unencrypted data may be stored as unencrypted and/or sent to the device unencrypted and/or remain unencrypted upon receipt. In some embodiments, unencrypted data is sent encrypted, and stored as unencrypted data on receipt. In contrast, other types of data, such as voice recognition data, are encrypted for enhanced security. This encrypted data is stored securely and sent as encrypted to prevent unauthorized access. In some embodiments, this data may be decrypted temporarily during synchronization and then re-encrypted after the process is complete. Additionally, this encrypted data might be stored as encrypted, unencrypted for a short period of time, and/or sent as encrypted to maintain a high level of security throughout the transfer process. This ensures that sensitive information remains protected during storage and transmission, reducing the risk of data breaches.

As illustrated in FIGS. 3A-3F, process 300 is performed by Bob 310 (e.g., a device associated with and/or assigned into a user account for and/or owned by user “Bob”), accessory device A 320 (e.g., a smart home accessory, such as a light, a speaker, a television, a security system, an air conditioning system, a heating system, blinds, a fan, and/or a robot vacuum), Alice 330 (e.g., a device associated with and/or assigned into a user account for and/or owned by user “Alice”), accessory device B 340 (e.g., a smart home accessory as described above), and server 350. It should be recognized that more, fewer, and/or different devices can be used with techniques described herein and that, in some embodiments, operations are combined, in a different order, and/or performed by different devices than illustrated in FIGS. 3A-3F.

At the beginning of FIG. 3A, neither Alice nor Bob have signed into accessory device A 320 and/or accessory device B 340; however, Bob has purchased both accessory device A 320 and accessory device B. FIG. 3A illustrates interactions between Bob 310 and accessory device A 320 to setup accessory device A 320 (e.g., add accessory device A 320 to a network and/or group of one or more accessory associated with and/or controlled by Bob 310).

At 302, accessory device A 320 sends an advertisement over Bluetooth to setup an accessory device (e.g., accessory device A 320). The advertisement can be a broadcast and/or a direct communication to Bob 310. In some embodiments, the advertisement indicates that accessory device A 320 is in a setup mode and/or ready to be setup. It should be recognized that Bluetooth is just one example of a communication method and that other communication methods can be used with techniques described herein, such as Wi-Fi and/or a peer-to-peer connection.

At 304, in response to receiving the advertisement, Bob 310 displays a user interface clement to setup accessory device A 320. In some embodiments, the user interface element is provided and/or managed by a system process and displayed on top of a user interface being displayed while receiving the advertisement. In other embodiments, the user interface element is provided and/or managed by an application associated with accessory device A 320 and displayed within a user interface of the application. In some embodiments, the user interface element includes an indication of a name of accessory device A 320 (e.g., “smart light,” and/or “smart TV”), a manufacturer of accessory device A 320 (e.g., “Generic Company”), and/or a model of accessory device A 320 (e.g., “Model 1234,” and/or “Generic Speaker Model”). After 304 and before 306, Bob 310 detects a request (e.g., selection input and/or non-selection input) to proceed with setup of accessory device A 320. For example, the request to proceed with setup of accessory device A 320 can include a tap input on the user interface element to “continue” setup. For another example, the request to proceed with setup of accessory device A 320 includes a voice input to continue setup.

At 306, in response to detecting the request to proceed with setup of accessory device A 320, Bob 310 begins to setup accessory device A 320. For example, Bob 310 can send a request to accessory device A 320 to display a code (e.g., a PIN code, a nonce, and/or a set of one or more characters) to be used to confirm which device that Bob 310 is setting up and/or to establish a secure communication.

At 308, in response to receiving the request to display a code, accessory device A 320 displays a PIN code. In some embodiments, the PIN code is randomly generated by accessory device A 320 and includes multiple numeric and/or alphanumeric characters. For example, the PIN code can be 5421.

At 312, after accessory device A 320 displays the PIN code, Bob 310 sends a request to establish a secure Bluetooth channel using the PIN code that was displayed by accessory device A 320. For example, the PIN code can be input on Bob 310 and sent to accessory device A 320 to establish the secure Bluetooth channel. For another example, the PIN code can be input on Bob 310 and used to generate a signature and/or to encrypt a message sent to accessory device A 320. At 314, after the secure Bluetooth channel is established, communication between accessory device A 320 and Bob 310 is encrypted using the secure Bluetooth channel.

At 316, while communication between accessory device A 320 and Bob 310 are encrypted, Bob 310 signs into accessory device A 320. For example, Bob 310 can send a credential (e.g., for an account that Bob 310 is already logged into) to accessory device A 320 so that accessory A 320 can sign into a remote service (e.g., a server and/or other device that Bob 310 and/or accessory device A 320 are in communication with) using the credential. In some embodiments, Bob 310 signs into accessory device A 320 using the secure Bluetooth channel. In some embodiments, signing into accessory device A 320 includes granting access to accessory device A 320 to data associated with Bob's account. For example, accessory device A 320 synchronizes settings with Bob's account by receiving and sending data of Bob's account from a server (e.g., server 350, described below) and/or from Bob 310. In some embodiments, the settings synchronized with Bob's account include encrypted data, such as Bob's voice recognition data and/or Bob's previous phone call history. In some embodiments, the settings synchronized with Bob's account include unencrypted data, such a Bob's favorited movies and/or language preference settings.

At 318, after Bob 310 signs into accessory device A 320, Bob 310 displays a user interface element to “sync with other accessory devices in this home,” and, in response to detecting a selection of the user interface element, sends, to accessory device A 320, a request to synchronize device A 320 with other accessories in the home associated with Bob's account. In some embodiments, accessory devices in the home include devices signed into Bob's account that are on the same network and/or within the same geographic location (e.g., same city, neighborhood, and/or physical building). In some embodiments, Bob sets up a home by signing multiple devices into Bob's account, assigning a group name, logging into a common network, and/or assigning a physical location. For example, Bob might create a group called “Bob's Home” that includes his smart thermostat, security system, and smart lights for synchronized control and settings. In some embodiments, Bob, as the primary owner and/or default user, does not get automatically signed into any of the devices in the home and sets up each device using 302-316 (e.g., as described above). Other users, like Alice, can automatically sign-in to Bob's home devices if they consent to synchronizing accessory devices in the home (e.g., 318). In some embodiments, at 318, Bob 310 adds accessory device A 320 to the group of Bob's devices that sync users and settings. For example, accessory device A 320 is streaming device and Bob might add his new streaming device to the “Bob's Home” group, allowing it to sync users and settings with his existing smart thermostat, security system, and smart lights for seamless control.

At 322, in response to receiving the request to synchronize with other accessories in the home, Bob 310 generates one or more personal signing keys (sometimes referred to as Bob's personal signing keys) and saves them to a remote storage location (e.g., a server and/or other device that does not belong to the same network as Bob 310 and/or accessory device A 320). In some embodiments, the one or more personal signing keys includes a public key (sometimes referred to as Bob's personal signing public key) and a corresponding private key (sometimes referred to as Bob's personal signing private key). In some embodiments, the remote storage location is accessible to full peers of Bob 310. In some embodiments, full peers are devices that have been granted the same level of access and verification credentials as Bob 310. For example, Bob's personal laptop, acting as a full peer of Bob 310, accesses the remote storage location to synchronize important files and updates. For another example, Bob's smartphone, another full peer, retrieves the latest contact information from the remote storage location, ensuring all devices remain up-to-date and securely synchronized. For another example, accessory device A 320, acting as a partial peer of Bob 310, either does not have access to the remote storage location and/or has limited access as compared to a full peer. Such limited access can include only access to (1) certain portions of the remote storage location and/or (2) the remote storage location at certain times and/or when certain criteria is satisfied (e.g., Bob 310 being on the same network as accessory device A 320). In some embodiments, Bob 310 generates and saves the one or more personal signing keys before initiating setup of accessory device A 320. For example, Bob 310 can generate and save the one or more personal signing keys when setting up a different device, such as a different accessory device. For another example, Bob 310 can generate and save the one or more personal signing keys when setting up Bob's account on a device owned by and signed in by Bob (e.g., Bob 310). In some embodiments, the one or more personal signing keys are specific to Bob's account and/or the home assigned to the device. For example, when Bob's account has been signed into multiple devices and assigned the same home, the one or more personal signing key for a home is shared with devices at that home. In this example, devices at a different home that are signed into Bob's account have a different set of personal signing keys. In some embodiments, the public key and/or the public key is used to encrypt, decrypt, and/or generate signatures for data associated with Bob's account. In some embodiments, a public key is used to encrypt data and verify digital signatures, and it can be shared openly. In some embodiments, a private key is kept secret and is used to decrypt data encrypted with the public key and to create digital signatures to verify communication. For example, the public key can be used by accessory device A to decrypt data associated with Bob 310, to encrypt data sent to Bob 310, to generate a signature to send with a message to Bob 310, and/or to validate a signature received from Bob 310. For another example, the private key can be used by Bob 310 to encrypt data associated with Bob 310, to decrypt data received from other devices, and/or to generate a signature for messages sent by Bob 310.

At 324, after generating the one or more personal signing keys (and/or in response to receiving the selection to sync with other accessory devices), Bob 310 sends Bob's personal signing public key to accessory device A 320. At 326, accessory device A 320 saves Bob's personal signing public key to a container in accessory device A 320. In some embodiments, the container is limited such that the container has limited access by processes of accessory device A 320 and/or includes limited types of data (e.g., public and/or private keys and/or other security-related data). In some embodiments, the container is not accessible outside of accessory device A 320 and/or is only accessible via a predefined communication method such as an API.

At 328, after generating the one or more personal signing keys (and/or in response to receiving the request to sync with other accessory devices), accessory device A 320 generates one or more group signing keys (sometimes referred to as Bob's group signing keys) and saves to the container in accessory device A 320. In some embodiments, Bob's group signing keys includes a public key and/or a corresponding private key to sync Bob's account with other accessories at the home (as described below). It should be recognized that other devices can generate Bob's group signing keys, such as Bob 310 and/or another device.

At 332, after saving Bob's personal signing public key and generating and saving Bob's group signing keys, accessory device A 320 completes setup and sends a notification that the setup is complete to Bob 310.

Process 300 continues in FIG. 3B between accessory device A 320 and Alice 330. After Bob 310 signed into accessory device A 320, Alice seeks to sign into accessory device A 320 using a device signed into their account (e.g., Alice 330). By signing into accessory device A 320, Alice is seeking to add herself as a secondary user. In some embodiments, a secondary user is a user account added to a device that is not the owner of the device. For example, Bob has already signed into accessory device A 320 using Bob's account (e.g., see the above description at FIG. 3A) as a primary user. In some embodiments the primary user has additional controls for the device than a secondary user. For example, the primary user can remove secondary users, but a secondary user cannot remove a primary user. At 334, accessory device A 320 displays a user interface with an option to “add new user” and detects selection of the option to “add new user”. For example, the user interface includes a button labeled “add new user” and the selection includes a tap user input on the button. For another example, the user interface displays the option to “setup new user” and accessory device A 320 receives a voice input to setup the new user (e.g., “please setup a new user”).

At 336, in response to detecting the selection to add the new user, accessory device A 320 advertises over Bluetooth to Alice 330, that the user selected to setup a new user. At 338, in response to receiving the advertisement over Bluetooth that the user selected to setup the new user, Alice 330 shows a user interface element to add the new user (Alice's account) to accessory device A 320. In some embodiments, Alice can add her account to accessory device A 320 without requiring approval from Bob 310. For example, Alice might simply tap a button on her device to complete the setup. In other embodiments, after 338 and before 342, Bob 310 detects a request (e.g., selection input and/or non-selection input) to add Alice's account to accessory device A 320. For example, the request to proceed with adding Alice's account to accessory device A 320 can include a tap input on a user interface element or a voice command (e.g., “please add me”).

At 342, in response to detecting the request to proceed with setting up accessory device A 320, Alice 320 begins to add the secondary user (e.g., Alice's account). For example, Alice 330 can send a request to accessory device A 320 to display a code (e.g., a PIN, a nonce, and/or a set of one or more characters) to be used to confirm which device that Alice 330 would like to setup and/or to establish a secure communication.

At 344, after beginning to add Alice's account, accessory device A 320 displays a PIN code. At 346, after displaying the PIN code, accessory device A 320 and Alice 330 setup a secure connection over Bluetooth with the PIN code that was displayed. At 348, after setting up the secure connection, communication between accessory device A 320 and Alice 330 is encrypted. In some embodiments, after Alice 330 establishes the secure connection and/or communication between the devices is encrypted, Alice 330 signs into accessory device A 320 using the secure connection. In some embodiments, accessory device A 320 synchronizes settings with Alice's account. For example, the settings synchronized with Alice's account include encrypted data, such as Alice's voice recognition data and/or Alice's calendar events. In some embodiments, the settings synchronized with Alice's account include unencrypted data, such a Alice's favorited music and/or subtitle preference settings.

Between 348 and 352, Alice 330 displays on a user interface a user interface element to synchronize with other accessory devices in this home where Bob is the primary user.

At 352, after and/or while communication between accessory device A 320 and Alice 330 is encrypted (and/or after displaying the user interface element to synchronize with other accessory devices in the home where Bob is the primary user), Alice 330 detects and sends to accessory device A 320 a request to synchronize with other accessory devices in the home where Bob is the primary user. In some embodiments, the detected request to synchronize with other accessory devices in the home where Bob is the primary user includes detecting a selection of a user interface element. In some embodiment, the detected request to synchronize with other accessory devices in the home where Bob is the primary user includes detecting a keyboard input corresponding to the user interface element. At 352, syncing with other accessory devices in the home where Bob is the primary user includes synchronizing data between accessory device A 320 and other devices at the home. For example, if Bob's account was signed into additional devices at the home, Alice 330 can also be signed into those additional devices through this process without needing to sign in manually at each device.

At 352, the synchronization process involves Alice 330 requesting to sync with other accessory devices in the home where Bob is the primary user. Unlike 318, which focuses on Bob adding devices to his group, 352 allows Alice to synchronize her data and settings across Bob's devices without needing to sign in manually on each one. For example, if Bob's account is already signed into additional devices, Alice can be automatically signed into those devices as well through this synchronization process. This means Alice can have seamless access to shared resources and settings on all of Bob's synchronized devices.

At 354, in response to receiving the request, accessory device A 320 sends to Alice 320 Bob's group and personal signing public keys, previously generated at 322 and 328 described above. At 356, in response to receiving Bob's group and personal signing public keys, Alice 330 saves to Alice's remote storage location (“Alice.remotestoragelocation.save) Bob's personal signing public key. Stated differently, at 356, Alice 330 securely stores Bob's personal signing public key in a remote storage location, ensuring it is readily accessible for future verification. In some embodiments, the remote storage location is specifically associated with Alice's account and is kept separate from other data to ensure secure and organized access control. For example, only Alice can access this storage location, preventing Bob from retrieving or altering the stored public key using this storage location.

At 358, in response to receiving Bob's group and personal signing public keys, Alice 330 saves Bob's group signing key to Alice's 330 remote storage location using Alice.remotestoragelocation.save (Bob's Group signing key). Stated differently, at 358, Alice 330 securely stores Bob's group signing key in a remote storage location, ensuring it is available for group-level communications in the future. In some embodiments, Bob's group signing public key enables Alice 330 to verify requests to synchronize data are from other devices at the home that are synchronized with Bob's account. In some embodiments, Bob's group signing public key is used to send commands to accessories in the home. These accessories will not respond to messages from Alice 330 unless Alive 330 uses this key, ensuring all communications with home accessories are verified and trusted.

Process 300 continues in FIG. 3C between Bob 310 and accessory device B 340. At 360, sometime after Alice 330 saved Bob's personal signing public key and Bob's group signing public key to the remote storage location, Bob 310 sets up accessory device B, a new accessory device at the home with Bob's account as the primary user of the device. The process of setting up accessory device B 340 are omitted herein for brevity. For example, the process of setting up accessory device B 340 are similar to the description in FIG. 3A with respect to 302, 304, 306, 308, 312, 314, and 316. In this example, 322, 324, 326, and 328 are omitted from setting up personal device B 340 because Bob's personal and group signing keys were previously generated by Bob 310 and stored by accessory device A 320.

At 362, after Bob 310 sets up accessory device B 340, Bob 310 completes setup and is signed into accessory device B. At 362, accessory device B 340 has access to accessory device B 340 container which includes Bob 310's group private key. At 364, after Bob 310 completes setup, accessory device B 340 configures a IDS firewall to only allow messages from home and/or family devices. In some embodiments, IDS (Internet Device Service) is a secure communication protocol used for internet messaging between devices. In some embodiments, the IDS firewall is located within the home network infrastructure and serves as a security barrier that monitors and controls incoming and/or outgoing network traffic. Configuring the IDS firewall restricts communication to only trusted devices that are recognized as part of the home or family network. At 366, after Bob 310 completes setup, accessory device B 340 assigns deviceIRK=accessory device B.remotestoragelocation.deviceIRK. Stated differently, at 366, accessory device B 340 is creating a device IRK, which identifies the location of the device. The assignment or ‘let’ sets the value to be set for deviceIRK, retrieved from its remote storage location.

At 368, accessory device B 340 assigns sepKey=generateSEPKey( ) to identify accessory device B 340. Stated differently, at 368, accessory device B 340 is generating a public and private key pair and storing the result in the memory of a secure element of accessory device B 340. The sepKey is stored in a highly secure location within the device, ensuring it remains more secret than other keys stored in remote locations. This key is used for the same verification purposes as other keys, but its enhanced security provides an additional layer of protection. The public part of the sepKey is used to verify the device's identity in a manner similar to other keys.

After 362, 364, 366, and 368, at 370, accessory device B 340 sends a challenge nonce and sepKey.publicKey over the encrypted Bluetooth channel using send (challengeNonce+sepKey.publicKey). Stated differently, at 370, accessory device B 340 transmits a random challenge value along with its public key securely over the encrypted Bluetooth connection. In some embodiments, a challenge nonce is a random value used during a verification process. For example, during verification, a device generates a challenge nonce that must be returned and signed to verify the identity of the sender. At 372, after sending the challenge nonce and public sepKey over the encrypted Bluetooth channel, accessory device B 340 fetches Bob's personal signing private key from the remote storage location. This step allows accessory device B 340 to sign messages, ensuring their integrity and authenticity. In some embodiments, full peers can then verify these signed messages using Bob's public key, establishing a secure and trusted communication network.

At 374, after receiving the challenge nonce and the sepKey over the encrypted bluetooth channel, Bob 310 responds with a message including a signature made using the challenge nonce, sepKey public key, and Bob's personal private key with sign (challengeNonce+sepKey.publicKey, Bob.privateKey). Stated differently, at 374, Bob 310 creates a unique signature using Bob's private key to sign the combination of the received challenge nonce and sepKey public key, which ensures the authenticity and integrity of the response.

At 376, after responding with the signature, accessory device 340 performs a local validation (signature, challengeNonce+sepKey.publicKey, Bob.persona.publicKey). This ensures the authenticity of the message by checking the signature against the combined challenge nonce and sepKey public key using Bob's public key. Upon successful validation of this check, accessory device B 340 assigns ownerSignature=signature. Stated differently, at 376, accessory device 340 checks the received signature against the challenge nonce and sepKey public key using Bob's personal public key to ensure the message's authenticity, then stores the verified signature as ownerSignature.

Process 300 continues in FIGS. 3D-3E between Alice 330 and accessory device B 340. At FIGS. 3D-3E, after Alice the user previously selected to synchronize with other accessory devices in the home and after Bob 310 synchronized a new device (e.g., accessory device B 340) to the home, Alice's account can now synchronize with the new device. In some embodiments, Alice's account can synchronize with the new device because of the above exchange of group signing keys.

At FIGS. 3D-3E, Alice's account is synchronized with accessory device B 340 without requiring Alice to individually sign in through one or more user inputs (e.g., on Alice 330), by using signing keys for Bob's home group and public key. This seamless synchronization process eliminates the need for manual entry. Before FIGS. 3D-3E, Alice 330 has not received a communication from accessory device B 340 to sign the user into accessory device B 340. At FIGS. 3D-3E, Alice's account is synchronized automatically with limited user input compared to manual sign in. In some embodiments, Alice 330 is not interacted with by a user. At FIGS. 3D-3E, Alice 330 does not need to be physically present near accessory device B 340. For example, Alice 330 can be in a different city or country from accessory device B 340.

Before 378, accessory device B 340 sends to Alice 330 a push token. In some embodiments, the push token notifies Alice 330 of the presence of the new device, accessory device B 340, in the home. In some embodiments, the push token includes a request to sign Alice's account into accessory device B 340. In some embodiments, the push token is sent because of the previous selection to automatically synchronize with new devices signed into Bob's account at the home (e.g., at 352).

At 378, after Bob 310 established the trusted signature and signed into accessory device B 340, Alice 330 initiates an exchange after resolving accessory device B 340's push token at 376. Upon resolving the push token, Alice 330 can securely communicate with accessory device B 340. Details of the flow are omitted here to keep this flow diagram a reasonable length.

After resolving accessory device B's push token at 376, at 380, Alice 330 requests remote sign in details via an IDS from accessory device B 340. In some embodiments, the IDS facilitates the transmission of verification and control messages to verify that accessory device B 340 and Alice 330 securely exchange information and commands over the internet. In some embodiments, the request for remote sign in details initiates a secure verification process, enabling Alice 330 to verify the necessary credentials to sign into accessory device B 340. During 380, Alice 330 requests the remote sign in details via IDS by assigning payload=deviceIRK, sepKey.publicKey, challengeNonce, and ownerSignature. Stated differently, at 380, Alice 330 prepares a set of secure data, including unique device identifiers and a signed challenge, to verify Alice's account identity and request access remotely. Alice 330 then assigns signature=sign (deviceIRK+sepKey.publicKey, Bob.group.privateKey). Stated differently, at 380 Alice 300 is creating a unique signature by combining the device identifier and the public key, and then signing this combination with Bob's group private key to ensure the request is verified. This payload contains elements for secure verification. The signature ensures that the request is verified by Bob's group private key, adding an extra layer of security to the remote sign in process.

At 382, in response to receiving the requested remote sign in details via IDS, accessory device B 340 sends a message with idsService.send (payload.signature) to Alice 330. This action transmits the payload requested at 380, which includes the deviceIRK, sepKey.publicKey, challengeNonce, ownerSignature, along with the unique signature described above with respect to 380. Sending the message with the payload at 382 ensures secure delivery of the remote sign in details. The IDS service facilitates this secure exchange, maintaining the integrity and authenticity of the communication between the devices. In some embodiments, the IDS service is the same method as the secure connection established at 378.

At 384, after receiving the payload.signature, Alice 330 performs verify (signature, deviceIRK+sepKey.publicKey, Bob.group.publicKey). Stated differently, at 384, Alice 330 verifies the signature by comparing the received signature to one that would be generated using the combination of deviceIRK and sepKey.publicKey with Bob's group public key. At 384, Alice 330 verifies the signature using Bob's group public key to ensure the legitimacy of the signature, confirming it was generated by an authorized entity within Bob's group of devices. At 386, after receiving the idsService, Alice 330 performs verify (ownerSignature, challengeNonce+sepKey.publicKey, Bob.personal.publicKey). Stated differently, at 386, Alice 330 validates the owner signature by comparing the received owner signature to one that would be generated using the combination of the challengeNonce and sepKey.publicKey with Bob's personal public key. At 388, after receiving the idsService, Alice 330 executes Alice.Cloud.remotestoragelocation.save (deviceIRK, sepKey.publicKey for accessory device B 340). Stated differently, Alice 330 saves the deviceIRK and sepKey.publicKey for accessory device B 340 to a remote storage location for Alice 330, ensuring that future communications with accessory device B 340 can be securely verified and/or encrypted. In some embodiments, each of 384, 386, and 388 can be performed in any order after receiving the idsService.

At 390, after saving the deviceIRK and sepKey.publicKey to the remote storage location, Alice 330 sends Alice.selfidentify to accessory device B 340. Stated differently, self-identification information is sent to accessory device B 340 through the IDS service, establishing Alice's 330 identity to accessory device B 340. In some embodiments, this sign-in does not provide access to more private data such as calendars or end-to-end encrypted data, which is granted by the process described below in FIG. 3E. For example, at 318, after Alice's account is signed in, Alice must enter a secondary passcode to access her encrypted calendar events on accessory device B 340. In some embodiments, the self-identification information includes a username of Alice's account, a password to Alice's account, an email address of Alice's account, a description of Alice's account, a definition of a set of one or more privileges (e.g., Alice's account has the ability to remove devices but not rename devices), an account description (e.g., Alice's account is for a user, Alice), a role (e.g., Alice's account is a guest account), and/or a unique identifier (e.g., a series of numbers and/or letters randomly generated, and/or a unique username). In some embodiments, the self-identification information is saved to accessory device B 340 for future verification of Alice 330.

At 392, after sending self-identification information, Alice 330 comes on the same Wi-Fi as accessory device B 340. In some embodiments, coming on the same Wi-Fi includes Alice 330 connecting to the same network as accessory device B 340. For example, Alice 330 physically moves to a physical location that enables connection to the Wi-Fi. At 394, after coming on the same Wi-Fi as accessory device B 340, a screen of Alice 330 is on and Alice 330 is unlocked. In some embodiments, an unlocked device is an unrestricted state of a device (e.g., less secure, more functional, and/or more information than a locked state in which a device can operate).

FIG. 3E continues process 300 between Alice 330 and accessory device B 340 to sign in Alice's account to accessory device B. At 396, after Alice 330 connects to the same Wi-Fi network as accessory device B 340 and the screen of Alice 330 is on and Alice 330 is unlocked, accessory device B 340 advertises over a new zero-configuration network (“zeroconf networking”) with deviceIRK. In some embodiments, the zero-configuration networking is used to allow devices to automatically discover each other and their offered services on a local network. For example, a television can announce its presence and capabilities to all devices on the same network without requiring manual setup, enabling users on the network to find and connect to the printer without manual setup. Advertising over the zero-configuration network enables accessory device B 340 to securely communicate its identity using the deviceIRK. At 398, after accessory device B 340 advertises over the new zero-configuration networking protocol with deviceIRK, Alice 330 scans the network using the zero-configuration network protocol. This scanning process allows Alice 330 to discover accessory device B 340. At 301, in response to scanning over the zero-configuration network, accessory device B 340 discovers Alice 330 via the new zero-configuration network based on the device IRK.

At 303, after accessory device B 340 is discovered via the new zero-configuration network based on deviceIRK, Alice 330 establishes a connection with accessory device B 340 using mutual verification. In some embodiments, mutual verification is a security process in which both parties in a communication session verify each other's identity before establishing a connection. At 305, accessory device B 340 confirms the connection with Alice 330 using mutual verification. This mutual verification process ensures that both devices verify each other, establishing a secure and trusted connection.

At 307, after confirming the connection with Alice 330 using mutual verification, Alice 330 fetches sepKey.publicKey for accessory device B 340 from Alice's 330 remote storage location using Alice.Cloud.remotestoragelocation.fetch(sepKey.publicKey for accessory device B). Stated differently, at 307, once the connection is verified, Alice 330 retrieves the secure element public key for accessory device B 340 from the remote storage location to use in the verification. At 309, Alice 330 sends a challenge nonce to accessory device B, which needs to be signed by accessory device B 340 using sepKey.privateKey. This step ensures that accessory device B can verify itself by signing the challenge nonce, verifying its identity using the private key.

At 311, accessory device B 340 fetches from its private remote storage location B.local.remote storage location.fetch(sepKey.privateKey for accessory device B 340) to verify the private key received is the same as what was received at 309. Stated differently, at 311, accessory device B 340 retrieves its secure element private key from local storage to confirm that it matches the private key received from Alice 330 at 309. Between 311 and 313, accessory device B 340 verifies the private key.

At 313, after verifying the private key received, accessory device B 340 signs the challenge nonce with sepKey.privateKey using sign(challengeNonce, sepKey.privateKey). Stated differently, at 313, accessory device B 340 confirms the private key's authenticity, and it uses this private key to create a signature for the challenge nonce. At 315, after confirming the private key's authenticity, Alice 330 verifies the signature using verify (signature, challengeNonce, sepKey.publicKey). Stated differently, Alice 330 ensures that the signature provided by accessory device B 340 is valid and corresponds to the challenge nonce, confirming the authenticity of accessory device B 340 using sepKey.publicKey.

At 317, in response to confirming the authenticity of the accessory using the public key, Alice 330 displays a user interface that includes a user interface element for Alice, the user, to give consent. At 317, Alice 330 detects a request to approve the consent. In some embodiments, the request to approve the consent includes detecting a tap input on the user interface element to consent. In some embodiments, the request to approve the consent includes detecting a voice input to approve signing into accessory device B 340 (e.g., “please sign me in to the new device”).

After Alice 330 detects the request to approve the consent, Alice 330 uses the secure channel established to sign Alice's account into accessory device B 340. In some embodiments, the request to sign Alice's account into accessory device B 340 involves an internet connection for additional verification steps. While Alice's account is signed into accessory device B 340, Bob's account remains signed into accessory device B 340. In some embodiments, when Alice's account is signed into accessory device B 340, data corresponding to Alice's account is downloaded from other accessory devices in the home and/or from a server (e.g., server 350, described below). For example, Bob has an additional accessory device C that is different from accessory device A and/or accessory device B that is signed into Alice's account. In this example, the data from accessory device C about Alice's account settings are downloaded during, before, and/or after sign in of Alice's account. In some embodiments, when Alice's account is signed (and/or after being signed in, before being signed in, and/or while being signed in) into accessory device B 340, accessory device B 340 sends to a different accessory device a request to sign a different user account into accessory device B 340. For example, while Alice's account is signing into accessory device B 340, accessory device B 340 sends to Johnny's account a request to sign into accessory device C. In this example, accessory device B 340 may send the request to Johnny's account data because Johnny, like Alice, also previously selected to synchronize settings across all devices at Bob's home. In some embodiments, when Alice's account is signed (and/or after being signed in, before being signed in, and/or while being signed in) into accessory device B 340 after Alice 330 detects the request to approve the consent, access to more private data, such as calendars or end-to-end encrypted data is enabled without the additional authentication process (e.g., as described above with respect to 390. For example, once Alice's account is fully signed in through this process, she gains access to her encrypted calendar events and other private data (e.g., without additional authentication).

In some embodiments, after Alice's account is signed into accessory device B 340, another device, accessory device D, already signed into Bob's account at the home is detected. In some embodiments, in response to detecting accessory device D, Alice 330 establishes a secure connection with accessory device D. In some embodiments, the secure connection is different from the communication established between Alice 330 and accessory device B 340. For example, the signature generated using the private key of accessory device B 340 is different from the private key of accessory device D. In some embodiments, the communication to sign Alice's account into accessory device D (e.g., local) is different from the communication to sign Alice's account into accessory device B 340 (e.g., internet). In some embodiments, the secure connection between Alice 330 and accessory device D is a local connection. For example, the secure connection is Bluetooth and/or Wi-Fi. In some embodiments, Bob is also signed into accessory device E, and Alice's account settings are downloaded from the accessory device E before being synchronized with the newly signed in devices (e.g., accessory device B 340 and/or accessory device D).

FIG. 3F continues process 300 between Alice 330, accessory device A 320, and server 350. FIG. 3F illustrates a process to temporarily unlock data between Alice 330, accessory device A 320, and server 350. Data that is synchronized between devices when a user account is signed into a device can fall into one of three categories: (1) unrestricted unencrypted data, (2) unrestricted encrypted data, and (3) restricted encrypted data. Restricted data can be data that is protected for containing sensitive personal information about a user and/or the user account. For example, restricted data can include text messages, phone calls, calendar events, emails, and/or particular media (e.g., an image, a video, and/or an audio recording) of a user. For another example, restricted data can includes sensitive data such as an image or model of Alice's face. In some embodiments, unrestricted data is data that is public and/or unprotected about a user and/or the user account. For example, unrestricted data can include music playlists, recommended videos, and/or purchased applications. In some embodiments, restricted encrypted data is restricted data that is decrypted and/or available to a user when the user is detected as present. For example, voice recognition data of a user can be decrypted by a device when a user is detected as present. In some embodiments, restricted data is also automatically unavailable when the user is not present. For example, when the user is no longer detected as present, voice recognition data of a user can be deleted and/or encrypted. In some embodiments, unrestricted encrypted data is restricted data that is decrypted and/or available to a user after the user provides their authorization a single time (e.g., subsequent times, the user does not need to provide their authorization). In such embodiments, the authorization might be required to be provided locally, such as via a local connection and/or a peer-to-peer connection. For example, a device can restricts access to the restricted data of paired Bluetooth devices until the first time the device detects the presence of the user. In some embodiments, unrestricted encrypted data is available even when the user is no longer detected as present after the user was detected as present one time. For example, if the user is no longer present at the device, the data of paired Bluetooth devices can be still available to the device. In some embodiments, unrestricted unencrypted data is unrestricted data that is available and/or unencrypted to a user at any time after the user's account is signed into a device, despite if the user is present or has been present. For example, music playlist history of a user account can be available to a user on a device at any time despite if the user was ever detected as present by the device. It should be recognized that despite the above discussion of three types of data, in some embodiments, two or more of these types of data may be present on a device and/or synched for a user account. In some embodiments, the two or more types of data include any combination of the three listed above.

At FIG. 3F, after a user, Alice has signed into accessory device A 320 (e.g., as described above), restricted data is decrypted and encrypted based on the presence of the user, Alice. The below discussion describes restricted data generally with particular examples for restricted encrypted data and unrestricted encrypted data. In some embodiments, the presence of Alice is determined by a camera, motion sensor, and/or detecting Alice 330 (e.g., on a network and/or in proximity to accessory device A 320). In some embodiments, the presence of Alice is determined by detecting Alice within a threshold distance of accessory device A 320. For example, the threshold distance can be 1-50 feet from accessory device A 320. In some embodiments, the presence of Alice is determined by detecting Alice 330 is connected to the same network as accessory device A 320. In some embodiments, the presence of Alice is determined by recognizing the voice of Alice. In some embodiments, the presence of Alice is determined using restricted data of Alice. For example, photos of Alice and/or the profile of Alice are restricted data. In this example, Alice's photos may be used to identify Alice even when they are restricted data.

Although the below describes decrypting and encrypting restricted data, it should be recognized that unrestricted unencrypted data from Alice's account (and/or other user's accounts) may be available regardless of if Alice is detected as present. In some embodiments, a request to display unrestricted unencrypted data displays the unrestricted unencrypted data on accessory device A 320. For example, a verbal request to display the unrestricted unencrypted data of a music playlist (e.g., “play Alice's playlist”) would be output in response to accessory device A 320 receiving the verbal request. In another example, when a user interface element of a food delivery application is displayed, accessory device A 320 detects a tap input on a widget to order food. In response to detecting the tap input on the widget to order food, accessory device A 320 displays a user interface of the food delivery application on accessory device A 320. In some embodiments, the unrestricted unencrypted content includes a user interface element identifying Alice's account.

In some embodiments, accessory device A 320 is signed into multiple accounts. For example, accessory device A 320 can be logged into Bob's account and Alice's account. In this example, unrestricted unencrypted content of Alice's account is still available when Bob the user's presence is detected. In this example, Bob's account is automatically swapped to Alice's account when Alice's presence is detected.

In some embodiments, before detecting the presence of Alice at 319, Alice's account is logged into (and/or authenticated with) accessory device A 320. In some embodiments, authentication into accessory device A 320 was automatic (e.g., without user input and/or using the synchronization settings described above at 318). In some embodiments, authentication into accessory device A 320 was a manual process.

Before starting at 319, accessory device A 320 detects no presence of Alice. In some embodiments, before detecting the presence of Alice, accessory device A 320 does not have access to restricted data of Alice's account. For example, if the restricted data is restricted encrypted data, the data is not available when Alice is not detected as present by accessory device A 320. For another example, if the restricted data is unrestricted encrypted data, the data is not available when Alice has not been previously detected as present by accessory device A 320. For another example, before detecting the presence of Alice, accessory device A 320 does not download the restricted data. For another example, before detecting the presence of Alice, accessory device A 320 downloads the restricted data but encrypts (and/or maintains the encryption of) the restricted data of Alice's account.

At 319, accessory device A 320 detects the presence of Alice. After detecting the presence of Alice, restricted data can be accessed by accessory device A 320. Accessory device A 320 accesses the restricted data by obtaining the data from Alice 330 at 321, and/or from server 350 at 323, and/or decrypted at 325. The data to be decrypted could have been received from Bob 310 at 321, server 350 at 323 and/or before the presence of Alice was detected at 319.

After obtaining the restricted data (and/or decrypting the restricted data), at 327, accessory device A 320 performs an operation using the restricted data. In some embodiments, performing the operation includes saving the restricted data to accessory device A 320 and/or Alice 330. In some embodiments, performing the operation includes outputting a portion of the restricted data via accessory device A 320. For example, Alice's text messages are displayed by accessory device A 320 while Alice's presence is detected. In some embodiments, performing the operation is in response to accessory device A 320 detecting an input to perform the operation. For example, accessory device A 320 detects a voice input to display today's event calendar that was previously restricted on accessory device A 320. In this example, in response to detecting the voice input, accessory device A 320 displays relevant calendar data. In another example, accessory device A 320 detects a tap input on a user interface element to display previous phone calls that were previously restricted on accessory device A 320. In this example, in response to detecting the tap input, accessory device A 320 displays a user interface including previous phone calls.

After performing the operation using the restricted data, at 329, accessory device A 320 detects Alice is no longer present. In some embodiments where the restricted data is restricted encrypted data, accessory device A 320 encrypts the data at 331 and/or deletes the restricted encrypted data on accessory device A 320, accessory device A 320 deletes the data at 333 after detecting Alice is no longer present. In some embodiments where the restricted data is unrestricted encrypted data, accessory device A 320 does not encrypt and/or delete the data because Alice was detected as present previously and the unrestricted encrypted data is still available.

FIG. 4 is a flow diagram illustrating a method (e.g., method 400) for automatically synchronizing data in accordance with some embodiments. Some operations in method 400 are, optionally, combined, the orders of some operations are, optionally, changed, and some operations are, optionally, omitted.

As described below, method 400 provides an intuitive way for automatically synchronizing data. Method 400 reduces the cognitive burden on a user, thereby creating a more efficient human-machine interface. For battery-operated computing devices, enabling a user to interact with such devices faster and more efficiently conserves power and increases the time between battery charges.

A first device (e.g., 340) sends (402) (e.g., transmits and/or communicates), to a second device (e.g., 330) (e.g., a computer system), a request (e.g., an instruction, a token, a push token (e.g., corresponding to the second device described below), a command, and/or an instruction) to sign (e.g., remotely sign, temporarily sign, and/or sign in with a reduced capacity) a first user account (e.g., Alice's account as described above with respect to FIGS. 3D-3E) into the first device (e.g., 340) (e.g., a computer system) different from the second device (e.g., before 378 as described above with respect to FIG. 3D). In some embodiments, the first device and/or the second device is a watch, a phone, a tablet, a fitness tracking device, a processor, a head-mounted display (HMD) device, a communal device, a media device, a speaker, a television, an electronic device, and/or a personal computing device. In some embodiments, the first device and/or the second device includes and/or is in communication with one or more input devices and/or one or more output devices, such as one or more cameras, speakers, microphones, sensors, and/or display generation components. In some embodiments, the second device is a different type of device (e.g., wearable, phone, media device, speaker, television, a communal device, user device, personal device, and/or personal computing device) than the first device. In some embodiments, the second device is the same type of device as the first device. In some embodiments, the second device is signed into the first user account. In some embodiments, the second device corresponds to the first user account. In some embodiments, the second device is a personal device of the first user account. In some embodiments, the request to sign the first user account into the first device corresponds to a request for the second device to authenticate the first user account so that the first device can have access to one or more resources of and/or corresponding to the first user account. In some embodiments, the request to sign the first user account into the first device is sent by the first device. In some embodiments, the request to sign the first user account into the first device is sent by another device (e.g., a hub device, a server, a set top box, a personal device, and/or a communal device) different from the first device and the second device.

After the request to sign the first user account (e.g., Alice's account as described above with respect to FIGS. 3D-3E) into the first device (e.g., 340) is sent, the first device (e.g., 340) receives (404), from the second device (e.g., 330), a response to the request to sign the first user account into the first device, wherein the response includes a request (e.g., an instruction, a command, and/or an instruction) for data corresponding to the first device (e.g., 340) (e.g., data that identifies and/or verifies (1) a group that includes the first device, (2) a group that includes the first user account, and/or (3) the first device) (e.g., as described above at 380). In some embodiments, the request is a request for remote sign in details.

In response to receiving the response, the first device (e.g., 340) sends (406) (e.g., transmits and/or communicates), to the second device (e.g., 330), data indicative of a group (e.g., an identification, a token, an indication, and/or an identifier of the group) (e.g., 382). In some embodiments, the data indicative of the group includes data corresponding to a group of one or more devices, such as the first device, the second device, and/or another device different from the first device and the second device. In some embodiments, the data indicative of the group includes data to verify a group of one or more devices, such as the first device, the second device, and/or another device different from the first device and the second device. In some embodiments, the group includes the first device and/or the second device. In some embodiments, the group does not include the first device and/or the second device.

After sending the data indicative of the group, the first device (e.g., 340) receives (408), from the second device (e.g., 330), data (e.g., user account data, a token, an identifier of the first user account, and/or a password and/or a passkey for the first user account) corresponding to the first user account (e.g., Alice's account as described above with respect to FIGS. 3D-3E) (e.g., as described above at 390). In some embodiments, after sending the data indicative of the group, the first device receives, from the second device, a response to the second device receiving the data indicative of the group. In some embodiments, the response includes the data corresponding to the first user account.

In response to receiving the data corresponding to the first user account (e.g., Alice's account as described above with respect to FIGS. 3D-3E), the first device (e.g., 340) signs (410) (e.g., remotely signs, temporarily signs, and/or signs in with a reduced capacity) the first user account into the first device (e.g., 340) (e.g., after 390 as described above with respect to FIG. 3D). In some embodiments, as a result of and/or in response to signing the first user account into the first device, the first device receives data corresponding to settings, media, applications, and/or purchase information of the first user account. In some embodiments, in response to and/or after receiving the data corresponding to settings, media, applications, and/or purchase information of the first user account, the first device outputs, the via one or more output devices, at least a portion of the data corresponding to settings, media, applications and/or purchase information of the first user account. In some embodiments, in response to and/or after signing the first user account into the first device, the first device changes from a locked state (e.g., (1) a state that requires a password and/or other information to be entered before the first device can transition into an unlocked state and/or (2) a state that is more secure, less functional, and/or include less information than another state in which the first device can operate) to an unlocked state. In some embodiments, in the unlocked state, the first device receives and/or outputs sensitive data such as an image, account settings, media, media preferences, calendar, and/or a message (e.g., a text and/or social media message) corresponding to the first user account.

In some embodiments, the request to sign the first user account into the first device is sent as a result of (and/or in response to a determination that) the first user account being included in the group (and/or in response to signing the second user account into the first device and in accordance with a determination that the group includes the first user account and the second user account) (e.g., as described above at 362). In some embodiments, the group includes the first user account and/or the second user account.

In some embodiments, the second user account (e.g., Bob's account as described above with respect to FIGS. 3A-3C) is a primary user account (e.g., an owner, an account with additional privileges and/or functionality relative to a secondary account, and/or only account currently signed into a device) on the first device (e.g., 340). In some embodiments, the first user account (e.g., Alice's account as described above with respect to FIGS. 3D-3E) is a secondary user account (e.g., a guest account, an account with less privileges and/or functionality relative to a primary account, and/or one account of multiple accounts currently signed into a device) on the first device (e.g., as described above at 390).

In some embodiments, the first device (e.g., 340) does not receive a communication from the second device (e.g., 330) before sending the request to sign the first user account (e.g., Alice's account as described above with respect to FIGS. 3D-3E) into the first device (e.g., as described above at FIG. 3D). In some embodiments, the first device does not receive a communication that originated from the second device before sending the request to sign the first user account into the first device. In some embodiments, the first device receives a communication from another device, different from the second device, with an indication of the group and/or an indication of the second device before sending the request to sign the first user account into the first device. In some embodiments, the first device sends the request to sign the first user account into the first device in response to receiving the communication from the other device. In some embodiments, the first device does not receive a communication with an indication and/or an identification corresponding to and/or of the second device before sending the request to sign the first user account into the first device is sent to the second device.

In some embodiments, the data indicative of the group includes a signature generated using a private key of (and/or corresponding to) the group (e.g., as described above at 382).

In some embodiments, the signature is generated using first address information (e.g., a device Identity Resolving Key (IRK), a Uniform Resource Identifier (URI), a Uniform Resource Locator (URL), an Internet Protocol (IP) address, a Media Access Control (MAC) address, and/or a unique identifier) of the first device (e.g., 340), a first public key of the first device, or a combination thereof (e.g., as described above at 382). In some embodiments, the first public key of the first device is a public device key of the first device. In some embodiments, the first public key of the first device corresponds to a private key stored in (and/or by) a secure element (e.g., a secure component, secure memory, and/or a secure process) of the first device. In some embodiments, the secure element of the first device is isolated from one or more other components of the first device, such as a central processing unit.

In some embodiments, the signature is sent in a message including second address information (e.g., the first address information or another address information different from the first address information) of the first device (e.g., 340), a second public key of the first device (e.g., the first public key or another public key different from the first public key), data (e.g., a signature, a public key, and/or an identifier) corresponding to a third device different from the first device and the second device (e.g., 330) (e.g., as described above at 382). In some embodiments, the data corresponding to the third device corresponds to an owner and/or a primary user account of the first device.

In some embodiments, the data corresponding to the first user account (e.g., Alice's account as described above with respect to FIGS. 3D-3E) includes identity information (e.g., a username, a password, an email address, an account description, an associated administrative group, a user group, a role, a unique identifier, and/or a definition of a set of one or more privileges) of the first user account (e.g., as described above at 390).

In some embodiments, before signing (e.g., locally signing, non-temporarily signing, permanently signing, long-term signing, and/or signing with an enhanced capacity relative to remotely signing, temporarily signing, and/or signing in with a reduced capacity) into the first user account (e.g., Alice's account as described above with respect to FIGS. 3D-3E) (and/or after remotely signing, temporarily signing, and/or signing in with a reduced capacity the first user account into the first device), the first device (e.g., 340) receives, from a fourth device (e.g., the second device, a server, and/or another device different from the second device) (e.g., accessory device C and/or accessory device E as described above after 317 with respect to FIG. 3E) different from the first device 340, user data (e.g., a user setting and/or application data) corresponding to the first user account (e.g., as described above after 390 with respect to FIG. 3D).

In some embodiments, the fourth device (e.g., accessory device C and/or accessory device E as described above after 317 with respect to FIG. 3E) is different from the second device (e.g., 330).

In some embodiments, in conjunction with (e.g., before, while, in response to, as a result of, concurrently with, and/or after) sending the request to sign the first user account (e.g., Alice's account as described above with respect to FIGS. 3D-3E) into the first device (e.g., 340), the first device (e.g., 340) sends (e.g., transmits and/or communicates), to a fifth device (e.g., accessory device E as described above after 317 with respect to FIG. 3E) different from the first device and the second device (e.g., 330), a request (e.g., an instruction, a token, a push token (e.g., corresponding to the second device described below), a command, and/or an instruction) to sign (e.g., remotely sign, temporarily sign, and/or sign in with a reduced capacity) a third user account (e.g., Johnny's account as described above with respect to FIG. 3E), different from the first user account, into the first device. In some embodiments, the fifth device is a watch, a phone, a tablet, a fitness tracking device, a processor, a head-mounted display (HMD) device, a communal device, a media device, a speaker, a television, an electronic device, and/or a personal computing device. In some embodiments, the fifth device is a different type of device (e.g., wearable, phone, media device, speaker, television, a communal device, user device, personal device, and/or personal computing device) than the first device and/or the second device. In some embodiments, the fifth device is the same type of device as the first device and/or the second device. In some embodiments, the fifth device is signed into the third user account. In some embodiments, the fifth device corresponds to the third user account. In some embodiments, the fifth device is a personal device of the third user account. In some embodiments, the request to sign the third user account into the first device corresponds to a request for the fifth device to authenticate the third user account so that the first device can have access to one or more resources of and/or corresponding to the third user account. In some embodiments, the request to sign the third user account into the first device is sent by the first device. In some embodiments, the request to sign the third user account into the first device is sent by another device (e.g., a hub device, a server, a set top box, a personal device, and/or a communal device) different from the first device, the second device, and the fifth device. In some embodiments, after the request to sign the third user account (e.g., Johnny's account as described above with respect to FIG. 3E) into the first device (e.g., 340) is sent, the first device (e.g., 340) receives, from the fifth device (e.g., accessory device E as described above after 317 with respect to FIG. 3E), a response to the request to sign the third user account into the first device, wherein the response includes a request (e.g., an instruction, a command, and/or an instruction) for data corresponding to the first device (e.g., data that identifies and/or verifies (1) a group that includes the first device, (2) a group that includes the first user account, and/or (3) the first device). In some embodiments, the request is a request for remote sign in details. In some embodiments, in response to receiving the response to the request to sign the third user account (e.g., Johnny's account as described above with respect to FIG. 3E) into the first device (e.g., 340), the first device (e.g., 340) sends (e.g., transmits and/or communicates), to the fifth device (e.g., accessory device E as described above after 317 with respect to FIG. 3E), the data indicative of the group. In some embodiments, the group includes the fifth device. In some embodiments, the group does not include the fifth device. In some embodiments, after sending the data indicative of the group to the fifth device, the first device (340) receives, from the fifth device (e.g., accessory device E as described above after 317 with respect to FIG. 3E), data (e.g., user account data, a token, an identifier of the third user account, and/or a password and/or a passkey for the third user account) corresponding to the third user account (e.g., Johnny's account as described above with respect to FIG. 3E). In some embodiments, after sending the data indicative of the group to the fifth device, the first device receives, from the fifth device, a response to the fifth device receiving the data indicative of the group. In some embodiments, the response to the fifth device receiving the data indicative of the group includes the data corresponding to the third user account. In some embodiments, in response to receiving the data corresponding to the third user account (e.g., Johnny's account as described above with respect to FIG. 3E), the first device (e.g., 340) signs (e.g., remotely signs, temporarily signs, and/or signs in with a reduced capacity) the third user account into the first device (e.g., 340). In some embodiments, as a result of and/or in response to signing the third user account into the first device, the first device receives data corresponding to settings, media, applications, and/or purchase information of the third user account. In some embodiments, in response to and/or after receiving the data corresponding to settings, media, applications, and/or purchase information of the third user account, the first device outputs, the via one or more output devices, at least a portion of the data corresponding to settings, media, applications and/or purchase information of the third user account. In some embodiments, in response to and/or after signing the third user account into the first device, the first device changes from a locked state (e.g., (1) a state that requires a password and/or other information to be entered before the first device can transition into an unlocked state and/or (2) a state that is more secure, less functional, and/or include less information than another state in which the first device can operate) to an unlocked state. In some embodiments, in the unlocked state, the first device receives and/or outputs sensitive data such as an image, account settings, media, media preferences, calendar, and/or a message (e.g., a text and/or social media message) corresponding to the third user account.

In some embodiments, the first device (e.g., 340) is concurrently signed into the first user account (e.g., Alice's account as described above with respect to FIGS. 3D-3E) and the second user account (e.g., Bob's account as described above with respect to FIGS. 3A-3C) (e.g., the first user account and the second user account are both active accounts on the first device at the same time).

In some embodiments, after signing the first user account (e.g., Alice's account as described above with respect to FIGS. 3D-3E) into the first device (e.g., 340), the first device (e.g., 340) detects that the second device (e.g., 330) is on the same network (e.g., local network) as the first device (e.g., as described above after 317). In some embodiments, in response to detecting that the second device (e.g., 330) is on the same network as the first device (e.g., 340), the first device (e.g., 340) establishes a secure connection with the second device (e.g., as described above after 303 and/or 305). In some embodiments, establishing the secure connection with the second device includes generating one or more keys (e.g., a private key and a public key that corresponds to the private key) and sending a portion of the one or more keys (e.g., the public key) to the second device. In some embodiments, establishing the secure connection with the second device includes receiving one or more keys (e.g., a public key) from the second device.

In some embodiments, after establishing the secure connection with the second device (e.g., 330), the first device (e.g., 340) sends, to the second device via the secure connection, a signature generated using a private key of the first device (e.g., 340) for the purpose of the second device verifying the first device using data (e.g., a public key, corresponding to the private key of the first device, of the first device) received from the first device via a different communication channel than the secure connection (and/or data, such as a nonce, sent to the first device via the secure connection) (e.g., as described above at 309). In some embodiments, the data received from the first device is data sent with (e.g., in the same message as) the data indicative of the group.

In some embodiments, the secure connection is a local connection (e.g., Bluetooth, Wi-Fi, and/or peer-to-peer connection). In some embodiments, the request to sign the first user account (e.g., Alice's account as described above with respect to FIGS. 3D-3E) into the first device (e.g., 340) is sent via a global connection (e.g., the Internet) (e.g., as described above at 380). In some embodiments, the response to the request to sign the first user account into the first device is received via the global connection. In some embodiments, the data indicative of the group is sent via the global connection. In some embodiments, the data corresponding to the first user account is received via the global connection.

In some embodiments, after establishing the secure connection (and/or while the secure connection is established), the first device (e.g., 340) accesses (e.g., obtains via the secure connection, receives via the secure connection, and/or decrypts using data received via the secure connection) user data (e.g., voice data, image data, identification data, and/or a list of paired devices) corresponding to the first user account (e.g., Alice's account as described above with respect to FIGS. 3D-3E) (e.g., as described below with respect to CS2), wherein the user data is not accessible to the first device (e.g., 340) as a result of signing the first user account into the first device (e.g., the user data is accessible to the first device while the secure connection is established) (e.g., as described above after 390).

In some embodiments, the user data is received from a fourth device (e.g., a server and/or other type of device) (e.g., accessory device E as described above after 317) different from the second device (e.g., 330). In some embodiments, the user data is received from the second device.

In some embodiments, the first user account (e.g., Alice's account as described above with respect to FIGS. 3D-3E) is a secondary user account (e.g., as described above) on the first device (e.g., 340). In some embodiments, the first user account is a primary user account (e.g., as described above) on the second device (e.g., 330).

Note that details of the processes described above with respect to method 400 (e.g., FIG. 4) are also applicable in an analogous manner to other methods described herein. For example, method 500 optionally includes one or more of the characteristics of the various methods described above with reference to method 400. For example, ceasing access of a first set of data of method 500 where the first set of data is of the first user can occur before sending to a second device a request to sign the first user account into a first device of method 400. For brevity, these details are not repeated herein.

FIG. 5 is a flow diagram illustrating a method (e.g., method 500) for causing data to be available based on presence in accordance with some embodiments. Some operations in method 500 are, optionally, combined, the orders of some operations are, optionally, changed, and some operations are, optionally, omitted.

As described below, method 500 provides an intuitive way for ensuring available data based on presence. Method 500 reduces the cognitive burden on a user, thereby creating a more efficient human-machine interface. For battery-operated computing devices, enabling a user to interact with such devices faster and more efficiently conserves power and increases the time between battery charge.

In some embodiments, process 500 is performed at a device (e.g., a computer system) (e.g., 320). In some embodiments, the device is a watch, a phone, a tablet, a fitness tracking device, a processor, a head-mounted display (HMD) device, a communal device, a media device, a speaker, a television, an electronic device, and/or a personal computing device. In some embodiments, the device includes and/or is in communication with one or more output devices, such as a display generation component, an audio generation component, a haptic generation component, a Bluetooth radio, a near-field communication radio, and/or a Wi-Fi radio. In some embodiments, the display generation component includes a display screen, a projector, a head mounted display, and/or a touch-sensitive display. In some embodiments, the audio generation component includes a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output.

While a first set of data (e.g., restricted encrypted data as described above with respect to FIG. 3F) corresponding to a user (e.g., a user account, a subject, a person, an animal, another computer system different from the computer system, a device, and/or an object) is unavailable to the device (e.g., 320) (e.g., encrypted, locked, stored on another device, different from the device, without access by the device), the device detects (502) a presence of the user (e.g., the user is within a threshold distance of a location and/or a device corresponding to and/or logged into an account, such as a user account, of the user is connected to a network in which the device is also connected, such as a home network) (e.g., in an environment) (e.g., as described above at 319). In some embodiments, the device includes and/or is in communication with one or more input devices (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface). In some embodiments, the presence of the user is detected via the one or more input devices. In some embodiments, detecting the presence of the user includes detecting movement and/or proximity of the user. In some embodiments, detecting the presence of the user includes identifying the user. In some embodiments, identifying the user includes facial recognition and/or detecting the presence of another device, different from the device, that corresponds to, associated with, and/or logged into an account of the user. In some embodiments, the first set of data corresponding to the user includes sensitive data, such as an image, account settings, media, media preferences, calendar, and/or a message (e.g., a text and/or social media message) corresponding to the user.

In response to (and/or after) detecting the presence of the user (e.g., and while continuing to detect the presence of the user), the device accesses (504) (e.g., decrypts and/or obtains from another device different from the device) the first set of data (e.g., restricted encrypted data as described above with respect to FIG. 3F) corresponding to the user (e.g., as described above at 321, 323, and/or 325). In some embodiments, in response to (and/or after) detecting the presence of the user (e.g., and while continuing to detect the presence of the user), the device unlocks the first set of data (e.g., causes the first set of data to become available to the device).

After (and/or while) accessing the first set of data (e.g., restricted encrypted data as described above with respect to FIG. 3F) corresponding to the user, the device detects (506) that the user is no longer present (e.g., in the environment) (e.g., 329).

In response to detecting that the user is no longer present, the device ceases (508) access of (e.g., deletes, ceases to receive, loses access to, and/or encrypts, such as when the device does not have the ability to decrypt (e.g., a key to decrypt) while the user is no longer present) the first set of data (e.g., restricted encrypted data as described above with respect to FIG. 3F) (e.g., as described above at 331 and/or 333).

In some embodiments, the presence of the user is detected while a second set of data (e.g., non-sensitive data, such as an identifier of the user, an account of the user, and/or another device of the user) (e.g., unrestricted encrypted data as described above at FIG. 3F), different from the first set of data (e.g., restricted encrypted data as described above with respect to FIG. 3F), corresponding to the first user, is available to the device (e.g., 320).

In some embodiments, the device (e.g., 320) is in communication with one or more input devices (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface) and one or more output devices (e.g., a display generation component, an audio generation component, and/or a haptic generation component). In some embodiments, the display generation component includes a display screen, a projector, a head mounted display, and/or a touch-sensitive display. In some embodiments, the audio generation component includes a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output. In some embodiments, the device detects (e.g., before or after detecting the presence of the user and/or before or after accessing the first set of data corresponding to the user), via the one or more input devices, an input (e.g., corresponding to a request to perform an operation) (e.g., as described above at FIG. 3F). In some embodiments, the input includes a verbal request to perform an operation that corresponds to the user, that requires disambiguation between multiple users (e.g., via the second set of data), and/or that is based on and/or uses the second set of data. In some embodiments, in response to detecting the input, the device outputs, via the one or more output devices, content based on (and/or using) the second set of data (e.g., unrestricted encrypted data as described above with respect to FIG. 3F).

In some embodiments, the second set of data (e.g., unrestricted encrypted data as described above with respect to FIG. 3F) includes an identifier of (and/or corresponding to) the user.

In some embodiments, the device (e.g., 320) is connected to a network (e.g., a local or global network as described above with respect to method 400). In some embodiments, detecting the presence of the user includes detecting that a device (e.g., a personal device) of the user is connected to the network (e.g., as described above with respect to FIG. 3F).

In some embodiments, detecting the presence of the user includes detecting that the user (and/or a device of the user) is within a threshold distance (e.g., 0-50 feet) of the first device (e.g., as described above with respect to FIG. 3F). In some embodiments, the user is detected within the threshold distance of the first device using signal strength, a camera, GPS coordinate, triangulation, radar, sonar, LIDAR, depth sensor, and/or a microphone.

In some embodiments, the device (e.g., 320) is in communication with (and/or includes) one or more microphones. In some embodiments, detecting the presence of the user includes detecting, via the one or more microphones, an audio input. In some embodiments, detecting the presence of the user includes recognizing, using the audio input, a voice of the user (e.g., as described above with respect to FIG. 3F).

In some embodiments, before detecting the presence of the user, the device signs (e.g., remotely signs, temporarily signs, and/or signs in with a reduced capacity) a user account corresponding to the user into the device (e.g., 320) (e.g., as described above with respect to method 400). In some embodiments, the first set of data is not available to the device in response to signing the user account into the device. In some embodiments, the first set of data requires the presence of the user to be detected while the user account is signed into the device to become available to the device.

In some embodiments, the device (e.g., 320) is in communication with (and/or includes) one or more input devices (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface). In some embodiments, the user account corresponding to the user is signed into the device without detecting one or more inputs via the one or more input devices (e.g., the user account is signed into the device in response to another device, different from the device, detecting one or more inputs) (e.g., as described above with respect to FIGS. 3D-3E). In some embodiments, the first set of data is available to the device in response to signing the user account into the device via the device rather than via another device different from the device.

In some embodiments, the device (e.g., 320) is in communication with (and/or includes) one or more input devices (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface). In some embodiments, the user account corresponding to the user is signed into the device in response to detecting, via the one or more input devices, one or more inputs (e.g., as described above with respect to FIGS. 3D-3E). In some embodiments, the first set of data is available to the device in response to signing the user account into the device via the one or more input devices (e.g., while the presence of the user is detected).

In some embodiments, the first set of data (e.g., restricted encrypted data as described above with respect to FIG. 3F) includes media (e.g., an image, a face scan, a fingerprint scan, a video, and/or an audio recording).

In some embodiments, the device (e.g., 320) is logged into an account (e.g., a user account) (e.g., Bob's account as described above with respect to FIG. 3F) that does not correspond to (e.g., is not associated with and/or does not belong to) the user. In some embodiments, the device is logged into an account (e.g., a user account) corresponding to the user and the account that does not correspond to the user.

In some embodiments, the device (e.g., 320) is in communication with (and/or includes) one or more input devices (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface). In some embodiments, while detecting the presence of the user (and/or while the first set of data is available to the device), the device identifies, via the one or more input devices, using the first set of data (e.g., restricted encrypted data as described above with respect to FIG. 3F), the user in an environment (e.g., a physical and/or virtual environment). In some embodiments, identifying the user in the environment includes identifying, in an image, the user using the first set of data (e.g., another image of the user). In some embodiments, identifying the user in the environment includes identifying, in an audio input, the user using the first set of data (e.g., another audio input of the user). In some embodiments, after (and/or in response to) identifying the user, based on the identifying, the device performs an operation corresponding to the user (e.g., unlocks the device, displays content corresponding to the user, and/or outputs a response to an input detected via the one or more input devices by personalizing the response to the user) (e.g., as described above with respect to FIG. 3F).

Note that details of the processes described above with respect to method 500 (e.g., FIG. 5) are also applicable in an analogous manner to the methods described herein. For example, method 400 optionally includes one or more of the characteristics of the various methods described herein with reference to method 500. For example, signing a first user account into a first device of method 400 can occur for the user on the device before detecting the presence of the user and while a first set of data corresponding to the user is unavailable of method 500. For brevity, these details are not repeated herein.

In some embodiments, one or more of processes 400 and 500 (FIGS. 4 and 5) is performed at a first computer system (as described herein) via a system process (e.g., an operating system process) that is different from one or more applications executing and/or installed on the first computer system.

In some embodiments, one or more of processes 400 and 500 (FIGS. 4 and 5) is performed at a first computer system (as described herein) by an application that is different from a system process. In some embodiments, the instructions of the application, when executed, control the first computer system to perform one or more of processes 400 and 500 (FIGS. 4 and 5) by calling an application programming interface (API) provided by the system process. In some embodiments, the application performs at least a portion of one or more of processes 400 and 500 (FIGS. 4 and 5) without calling the API. In some embodiments, the application can be any suitable type of application, including, for example, one or more of: a browser application, a super-app that functions as an application execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform one or more of processes 400 and 500 (FIGS. 4 and 5) by calling an application programming interface (API) provided by the system process using one or more parameters. In some embodiments, exemplary APIs provided by the system process include one or more of: a Pairing API (e.g., for establishing secure connection, e.g., with an accessory), a Device detection API (e.g., for locating nearby devices, e.g., Apple TVs, other iPhones), a UIKit API (e.g., for generating user interfaces), a Location Detection API, a FindMy API, a Maps API, a Health Sensor API, a Sensor API, a Messaging API, a Push Notification API, a Streaming API, a collaboration API, a video conferencing API (e.g., FaceTime/SharePlay API), a web browser API (e.g., WebKit API), a CarPlay API, a Networking API, a WiFi API, a Bluetooth API, an NFC API, a UWB API, a Fitness API, a HomeKit API, NameDrop API, Photos API, Camera API, and/or an Image Processing API. In some embodiments, at least one API is a software module (e.g., a collection of computer-readable instructions) that provides an interface that allows a different module (e.g., API calling module) to access and use one or more functions, processes, procedures, data structures, classes, and/or other services provided by an OS implementation module of the system process. The API can define one or more parameters that are passed between the API calling module and the OS implementation module. The OS implementation module is an operating system software module (e.g., a collection of computer-readable instructions) that is constructed to perform an operation in response to receiving an API call via the API. In some embodiments, the OS implementation module is constructed to provide an API response (via the API) as a result of processing an API call.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve synchronization of data. The present disclosure contemplates that in some instances, this gathered data can include personal information data that uniquely identifies and/or is associated with a user. Such personal information data can include demographic data, user account data, calendar data, phone call history, photos, settings, location-based data, telephone numbers, email addresses, home addresses, or any other identifying information.

The present disclosure recognizes that the use of such personal information data, in the present technology, can be used to the benefit of users. For example, the personal information data can be used to identify a user and/or determine their location. Accordingly, use of such personal information data enables automatic synching of settings between devices. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, the determination a device has connected to the same network as another device can be done by inferring location based on non-personal information data or a bare minimum amount of personal information, such as other nearby networks.

What is claimed is:

1. A method, comprising:
sending, to a second device, a request to sign a first user account into a first device different from the second device;
after the request to sign the first user account into the first device is sent, receiving, from the second device, a response to the request to sign the first user account into the first device, wherein the response includes a request for data corresponding to the first device;
in response to receiving the response, sending, to the second device, data indicative of a group;
after sending the data indicative of the group, receiving, from the second device, data corresponding to the first user account; and
in response to receiving the data corresponding to the first user account, signing the first user account into the first device.

2. The method of claim 1, before sending the request to sign the first user account into the first device, signing a second user account, different from the first user account, into the first device, wherein the request to sign the first user account into the first device is sent as a result of the first user account being included in the group.

3. The method of claim 2, wherein the second user account is a primary user account on the first device, and wherein the first user account is a secondary user account on the first device.

4. The method of claim 1, wherein the first device does not receive a communication from the second device before sending the request to sign the first user account into the first device.

5. The method of claim 1, wherein the data indicative of the group includes a signature generated using a private key of the group.

6. The method of claim 5, wherein the signature is generated using first address information of the first device, a first public key of the first device, or a combination thereof.

7. The method of claim 5, wherein the signature is sent in a message including second address information of the first device, a second public key of the first device, data corresponding to a third device different from the first device and the second device.

8. The method of claim 1, wherein the data corresponding to the first user account includes identity information of the first user account.

9. The method of claim 1, further comprising:
before signing into the first user account, receiving, from a fourth device different from the first device, user data corresponding to the first user account.

10. The method of claim 9, wherein the fourth device is different from the second device.

11. The method of claim 1, further comprising:
in conjunction with sending the request to sign the first user account into the first device, sending, to a fifth device different from the first device and the second device, a request to sign a third user account, different from the first user account, into the first device;
after the request to sign the third user account into the first device is sent, receiving, from the fifth device, a response to the request to sign the third user account into the first device, wherein the response includes a request for data corresponding to the first device;
in response to receiving the response to the request to sign the third user account into the first device, sending, to the fifth device, the data indicative of the group;
after sending the data indicative of the group to the fifth device, receiving, from the fifth device, data corresponding to the third user account; and
in response to receiving the data corresponding to the third user account, signing the third user account into the first device.

12. The method of claim 1, wherein the first device is concurrently signed into the first user account and the second user account.

13. The method of claim 1, further comprising:
after signing the first user account into the first device, detecting that the second device is on the same network as the first device; and
in response to detecting that the second device is on the same network as the first device, establishing a secure connection with the second device.

14. The method of claim 13, further comprising:
after establishing the secure connection with the second device, sending, to the second device via the secure connection, a signature generated using a private key of the first device for the purpose of the second device verifying the first device using data received from the first device via a different communication channel than the secure connection.

15. The method of claim 13, wherein the secure connection is a local connection, and wherein the request to sign the first user account into the first device is sent via a global connection.

16. The method of claim 13, further comprising:
after establishing the secure connection, accessing user data corresponding to the first user account, wherein the user data is not accessible to the first device as a result of signing the first user account into the first device.

17. The method of claim 16, wherein the user data is received from a fourth device different from the second device.

18. The method of claim 1, wherein the first user account is a secondary user account on the first device, and wherein the first user account is a primary user account on the second device.

19. A non-transitory computer-readable storage medium storing one or more programs configured to be executed by one or more processors of a first device, the one or more programs including instructions for:
sending, to a second device, a request to sign a first user account into the first device different from the second device;
after the request to sign the first user account into the first device is sent, receiving, from the second device, a response to the request to sign the first user account into the first device, wherein the response includes a request for data corresponding to the first device;
in response to receiving the response, sending, to the second device, data indicative of a group;
after sending the data indicative of the group, receiving, from the second device, data corresponding to the first user account; and
in response to receiving the data corresponding to the first user account, signing the first user account into the first device.

20. A first device, comprising:
one or more processors; and
memory storing one or more programs configured to be executed by the one or more processors, the one or more programs including instructions for:
sending, to a second device, a request to sign a first user account into the first device different from the second device;
after the request to sign the first user account into the first device is sent, receiving, from the second device, a response to the request to sign the first user account into the first device, wherein the response includes a request for data corresponding to the first device;
in response to receiving the response, sending, to the second device, data indicative of a group;
after sending the data indicative of the group, receiving, from the second device, data corresponding to the first user account; and
in response to receiving the data corresponding to the first user account, signing the first user account into the first device.
